(19) United States
(12) Patent Application Publication
(10) Pub. No.: US 2026/0067932 A1
(43) Pub. Date: Mar. 5, 2026

(54) USING A UNIFIED FRAMEWORK FOR COORDINATED TRANSMISSION MODES

(71) Applicant: QUALCOMM Incorporated, San Diego, CA (US)

(72) Inventors: Sherief HELWA, San Diego, CA (US); George CHERIAN, San Diego, CA (US); Sameer VERMANI, San Diego, CA (US); Jialing Li CHEN, San Diego, CA (US); Gaurang NAIK, San Diego, CA (US); Abhishek Pramod PATIL, San Diego, CA (US); Alfred ASTERJADHI, San Diego, CA (US); Giovanni CHISCI, San Diego, CA (US); Sanket Sanjay KALAMKAR, San Diego, CA (US); Sai Yiu Duncan HO, San Diego, CA (US)

(21) Appl. No.: 19/318,026

(22) Filed: Sep. 3, 2025

Related U.S. Application Data
(60) Provisional application No. 63/690,703, filed on Sep. 4, 2024.

(51) Int. Cl. H04W 74/0816; H04B 7/06; H04W 24/10; H04W 28/02

(52) U.S. Cl. CPC H04W 74/0816; H04B 7/0696; H04W 24/10; H04W 28/0278

(57) ABSTRACT

This disclosure provides methods, components, devices and systems for using a unified framework for coordinated transmission modes, such as a coordinated beamforming (CBF) mode, a coordinated spatial reuse (CSR) transmission mode, and a dedicated transmission opportunity (TXOP) transmission mode. Some aspects more specifically relate to a sharing and shared access point (AP) exchanging communications that facilitate the utilization of a transmission mode. In some implementations, a first AP may transmit, to a second AP, a trigger message that includes an indication of a first station (STA) to be scheduled during a TXOP. The second AP may respond with an indication of whether the second AP can attenuate a transmit signal to the first STA to facilitate the CBF mode. The first STA may proceed with communications via the CBF mode, CSR mode, or dedicated mode in accordance with whether the second AP can attenuate the signal, among other considerations.

### CROSS REFERENCES

The present Application for Patent claims benefit of U.S. Provisional Patent Application No. 63/690,703 by HELWA et al., entitled “USING A UNIFIED FRAMEWORK FOR COORDINATED TRANSMISSION MODES,” filed Sep. 4, 2024, assigned to the assignee hereof, and expressly incorporated herein.

### TECHNICAL FIELD

This disclosure relates generally to wireless communication and, more specifically, to using a unified framework for coordinated transmission modes.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a first access point (AP). The method may include transmitting, to a second AP, a coordinated trigger request frame including first information associated with coordination of resources of a transmission opportunity (TXOP), receiving, from the second AP, a first response to the coordinated trigger request frame, where the first response includes second information associated with the coordination of the resources, and communicating, during the TXOP and in accordance with the second information of the first response, one or more messages of a transmission mode from a set of transmission modes including a coordinated transmission mode and a dedicated TXOP transmission mode.

Another innovative aspect of the subject matter described in this disclosure can be implemented in a first AP. The first AP may include a processing system that includes processor circuitry and memory circuitry that stores code. The processing system configured to cause the first AP to transmit, to a second AP, a coordinated trigger request frame including first information associated with coordination of resources of a TXOP, receive, from the second AP, a first response to the coordinated trigger request frame, where the first response includes second information associated with the coordination of the resources, and communicate, during the TXOP and in accordance with the second information of the first response, one or more messages of a transmission mode from a set of transmission modes including a coordinated transmission mode and a dedicated TXOP transmission mode.

Another innovative aspect of the subject matter described in this disclosure can be implemented in a first AP. The first AP may include means for transmitting, to a second AP, a coordinated trigger request frame including first information associated with coordination of resources of a TXOP, means for receiving, from the second AP, a first response to the coordinated trigger request frame, where the first response includes second information associated with the coordination of the resources, and means for communicating, during the TXOP and in accordance with the second information of the first response, one or more messages of a transmission mode from a set of transmission modes including a coordinated transmission mode and a dedicated TXOP transmission mode.

Another innovative aspect of the subject matter described in this disclosure can be implemented in a non-transitory computer-readable medium storing code for wireless communications at a first AP. The code may include instructions executable by one or more processors to transmit, to a second AP, a coordinated trigger request frame including first information associated with coordination of resources of a TXOP, receive, from the second AP, a first response to the coordinated trigger request frame, where the first response includes second information associated with the coordination of the resources, and communicate, during the TXOP and in accordance with the second information of the first response, one or more messages of a transmission mode from a set of transmission modes including a coordinated transmission mode and a dedicated TXOP transmission mode.

Another innovative aspect of the subject matter described in this disclosure can be implemented in a method for wireless communication at a first AP. The method may include receiving, from a second AP, a coordinated trigger request frame including first information associated with coordination of resources of a TXOP, transmitting, to the second AP, a first response to the coordinated trigger request frame, the first response including second information associated with the coordination of the resources, and communicating, during the TXOP and in accordance the second information of the first response, one or more messages of a transmission mode from a set of transmission modes including a coordinated transmission mode and a dedicated TXOP transmission mode.

Another innovative aspect of the subject matter described in this disclosure can be implemented in a first AP. The first AP may include a processing system that includes processor circuitry and memory circuitry that stores code. The processing system configured to cause the first AP to receive, from a second AP, a coordinated trigger request frame including first information associated with coordination of resources of a TXOP, transmit, to the second AP, a first response to the coordinated trigger request frame, the first response including second information associated with the coordination of the resources, and communicate, during the TXOP and in accordance the second information of the first response, one or more messages of a transmission mode from a set of transmission modes including a coordinated transmission mode and a dedicated TXOP transmission mode.

Another innovative aspect of the subject matter described in this disclosure can be implemented in a first AP. The first AP may include means for receiving, from a second AP, a coordinated trigger request frame including first information associated with coordination of resources of a TXOP, means for transmitting, to the first AP, a first response to the coordinated trigger request frame, the first response including second information associated with the coordination of the resources, and means for communicating, during the TXOP and in accordance the second information of the first response, one or more messages of a transmission mode from a set of transmission modes including a coordinated transmission mode and a dedicated TXOP transmission mode.

Another innovative aspect of the subject matter described in this disclosure can be implemented in a non-transitory computer-readable medium storing code for wireless communications at a first AP. The code may include instructions executable by one or more processors to receive, from a second AP, a coordinated trigger request frame including first information associated with coordination of resources of a TXOP, transmit, to the second AP, a first response to the coordinated trigger request frame, the first response including second information associated with the coordination of the resources, and communicate, during the TXOP and in accordance the second information of the first response, one or more messages of a transmission mode from a set of transmission modes including a coordinated transmission mode and a dedicated TXOP transmission mode.

Another innovative aspect of the subject matter described in this disclosure can be implemented in a method for wireless communication at a first station (STA). The method may include receiving, from a first AP, a null data packet announcement (NDPA) frame message including coordination information with a second AP, receiving, from the first AP in accordance with the NDPA frame message, a first null data packet (NDP) frame message, receiving, from the second AP in accordance with the NDPA frame message, a second NDP frame message, transmitting a channel state information (CSI) reporting frame including first measurement information associated with measurement of the first NDP frame message and a second measurement information associated with measurement of the second NDP frame message, and communicating with the first AP in accordance with transmission of the channel measurement information.

Another innovative aspect of the subject matter described in this disclosure can be implemented in a first STA. The first STA may include a processing system that includes processor circuitry and memory circuitry that stores code. The processing system configured to cause the first STA to receive, from a first AP, an NDPA frame message including coordination information with a second AP, receive, from the first AP in accordance with the NDPA frame message, a first NDP frame message, receive, from the second AP in accordance with the NDPA frame message, a second NDP frame message, transmit a CSI reporting frame including first measurement information associated with measurement of the first NDP frame message and a second measurement information associated with measurement of the second NDP frame message, and communicate with the first AP in accordance with transmission of the channel measurement information.

Another innovative aspect of the subject matter described in this disclosure can be implemented in a first STA. The first STA may include means for receiving, from a first AP, an NDPA frame message including coordination information with a second AP, means for receiving, from the first AP in accordance with the NDPA frame message, a first NDP frame message, means for receiving, from the second AP in accordance with the NDPA frame message, a second NDP frame message, means for transmitting a CSI reporting frame including first measurement information associated with measurement of the first NDP frame message and a second measurement information associated with measurement of the second NDP frame message, and means for communicating with the first AP in accordance with transmission of the channel measurement information.

Another innovative aspect of the subject matter described in this disclosure can be implemented in a non-transitory computer-readable medium storing code for wireless communications at a first STA. The code may include instructions executable by one or more processors to receive, from a first AP, an NDPA frame message including coordination information with a second AP, receive, from the first AP in accordance with the NDPA frame message, a first NDP frame message, receive, from the second AP in accordance with the NDPA frame message, a second NDP frame message, transmit a CSI reporting frame including first measurement information associated with measurement of the first NDP frame message and a second measurement information associated with measurement of the second NDP frame message, and communicate with the first AP in accordance with transmission of the channel measurement information.

Another innovative aspect of the subject matter described in this disclosure can be implemented in a method for wireless communication at a first AP. The method may include transmitting a scheduling frame including first information associated with coordination of resources of a TXOP, where the scheduling frame is transmitted in accordance with spatial dimensions supporting a coordinated beamforming transmission mode during a transmission mode being below a threshold quantity and communicating with one or more first STAs during the TXOP in accordance with the scheduling frame.

Another innovative aspect of the subject matter described in this disclosure can be implemented in a first AP. The first AP may include a processing system that includes processor circuitry and memory circuitry that stores code. The processing system configured to cause the first AP to transmit a scheduling frame including first information associated with coordination of resources of a TXOP, where the scheduling frame is transmitted in accordance with spatial dimensions supporting a coordinated beamforming transmission mode during a transmission mode being below a threshold quantity and communicate with one or more first STAs during the TXOP in accordance with the scheduling frame.

Another innovative aspect of the subject matter described in this disclosure can be implemented in a first AP. The first AP may include means for transmitting a scheduling frame including first information associated with coordination of resources of a TXOP, where the scheduling frame is transmitted in accordance with spatial dimensions supporting a coordinated beamforming transmission mode during a transmission mode being below a threshold quantity and means for communicating with one or more first STAs during the TXOP in accordance with the scheduling frame.

Another innovative aspect of the subject matter described in this disclosure can be implemented in a non-transitory computer-readable medium storing code for wireless communications at a first AP. The code may include instructions executable by one or more processors to transmit a scheduling frame including first information associated with coordination of resources of a TXOP, where the scheduling frame is transmitted in accordance with spatial dimensions supporting a coordinated beamforming transmission mode during a transmission mode being below a threshold quantity and communicate with one or more first STAs during the TXOP in accordance with the scheduling frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows a pictorial diagram of another example wireless communication network.

FIGS. 7A and 7B show examples of signaling diagrams that support using a unified framework for coordinated transmission modes.

FIG. 8 shows an example of a wireless communications system that supports using a unified framework for coordinated transmission modes.

FIG. 9 shows an example of an operation framework that supports using a unified framework for coordinated transmission modes.

FIGS. 10A and 10B show examples of signaling diagrams that support using a unified framework for coordinated transmission modes.

FIGS. 11A and 11B show examples of signaling diagrams that support using a unified framework for coordinated transmission modes.

FIG. 12 shows an example of a signaling diagram that supports using a unified framework for coordinated transmission modes.

FIG. 13 shows an example of an operation framework that supports using a unified framework for coordinated transmission modes.

FIG. 14 shows a block diagram of an example wireless communication device that supports using a unified framework for coordinated transmission modes.

FIG. 15 shows a block diagram of an example wireless communication device that supports using a unified framework for coordinated transmission modes.

FIGS. 16 and 17 show flowcharts illustrating example processes performable by or at a first access point that supports using a unified framework for coordinated transmission modes.

FIG. 18 shows a flowchart illustrating an example process performable by or at a first station that supports using a unified framework for coordinated transmission modes.

FIG. 19 shows a flowchart illustrating an example process performable by or at a first access point that supports using a unified framework for coordinated transmission modes.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communications networks, wireless communications devices may coordinate resources for a transmission opportunity (TXOP). Coordination of the resources may include a sharing access point (AP) and a shared AP exchanging messages associated with the coordination of the resources and STAs that are to be scheduled by one or more of the sharing AP and the shared AP for communications during the TXOP. Various types of coordinated access procedures may be implemented by the wireless communication devices such as to reduce interference between communications by the sharing AP and the shared APs and respective STAs. For example, a coordinated beamforming (CBF, or “Co-BF”) transmission mode may leverage hardware capabilities of an AP to null signals directed to overlapping basic service set (OBSS) STAs scheduled by another AP during the TXOP. A coordinated spatial reuse (CSR, or “Co-SR”) transmission mode relies on isolation between respective APs and STAs to coordinate resources (rather than actively nulling signals). The CBF and the CSR transmission modes may utilize various measurements reported by the STAs to coordinate resources in accordance with the utilized transmission modes. However, wireless communications device may leverage one type of measurement to implement one of the transmission modes to coordinate resources of a TXOP, but utilization of one or more different transmission modes, in accordance with various measurement considerations (among other considerations), may be beneficial for resource coordination and throughput.

Various aspects relate generally to a unified framework for implementing the CBF transmission mode, the CSR transmission mode, and a dedicated TXOP transmission mode (no shared TXOP resources between a sharing and shared AP). Some aspects more specifically relate to a sharing AP and a shared AP exchanging communications that facilitate the utilization of either a coordinated transmission mode (such as a symmetric CBF transmission mode, an asymmetric CBF transmission mode, or a CSR transmission mode) or a dedicated TXOP transmission mode. In some implementations, a first AP may transmit, to a second AP, a CBF trigger message that includes an indication of a first STA to be scheduled during a TXOP. In some implementations, the second AP may respond with an indication (such as an ACK/NACK) of whether the second AP can attenuate a transmit signal at the first STA to facilitate the CBF transmission mode. The first AP may proceed with communications via the CBF transmission mode (asymmetric or symmetric), CSR transmission mode, or dedicated transmission mode (the dedicated TXOP transmission mode) in accordance with whether the second AP can attenuate a transmit signal, whether the first STA is subject to interference by communications by the second AP, or both.

Some further aspects more specifically relate to additional signaling during a measurement phase of AP coordination. To facilitate the unified framework described herein, a wireless communications device (STA) may transmit, during a channel state information (CSI) reporting frame, measurement information that includes a CSI measurement and a received signal strength indicator (RSSI) measurement associated with a first transmission by the serving AP and a CSI measurement and an RSSI measurement associated with a second transmission by a second, non-serving AP. The APs may utilize at least a portion of this information to evaluate whether the APs are able to attenuate transmit signals for CBF transmission mode facilitation and to determine whether the served STAs are subject to interference by other APs such as to facilitate CSR transmission mode operations.

Particular aspects of the subject matter described in this disclosure can be implemented to realize one or more of the following potential advantages. In some implementations, by using the unified framework for facilitating the CBF transmission mode, the CSR transmission mode, or the dedicated TXOP transmission mode, the wireless communication devices may be able to utilize the transmission mode that supports communications in accordance with channel conditions between the wireless communications devices and capabilities of the wireless communications devices. Additionally, some transmission modes may provide greater communication performance and reliability, provided that operating conditions are suitable for those transmission modes, and particular aspects of the subject matter described in this disclosure facilitate selection and utilization of the transmission mode that suits a current operating condition. Moreover, in some implementations, the CSI reporting in conjunction with OBSS RSSI reporting may facilitate the selection and utilization of one of the transmission modes (such as one of a coordinated transmission mode or a dedicated TXOP transmission mode). In accordance with achieving such selection and utilization of a transmission mode, the described techniques can be further implemented to realize higher data rates, greater spectral efficiency, improved latency, and greater system capacity, among other benefits.

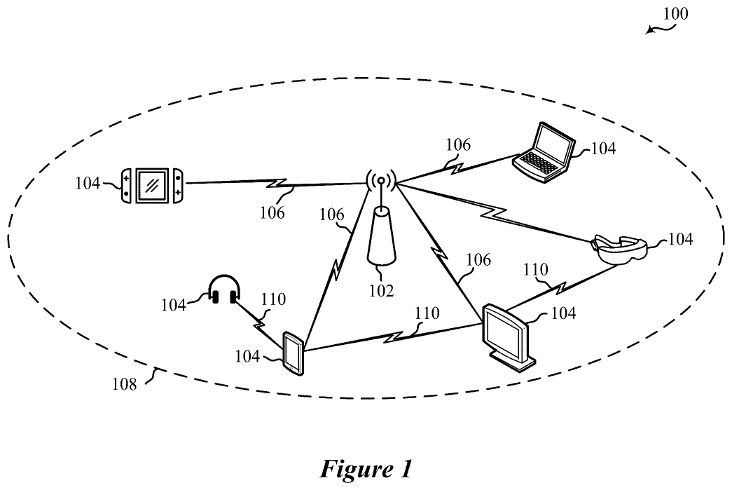

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.1 lay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater RSSI or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GH2, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHz), FR4a or FR4-1 (52.6 GHz-71 GHZ), FR4 (52.6 GHZ-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHZ, 80 MHZ, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHZ channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS may involve transmission on the primary 20 MHz channel. As such, in conventional systems, the transmitting device may contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

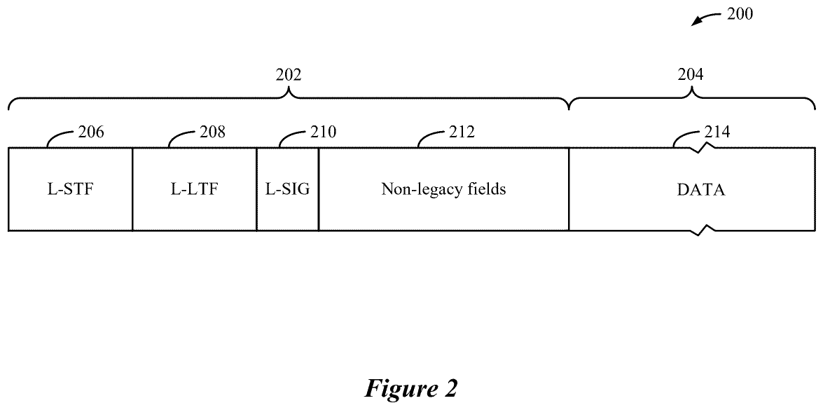

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

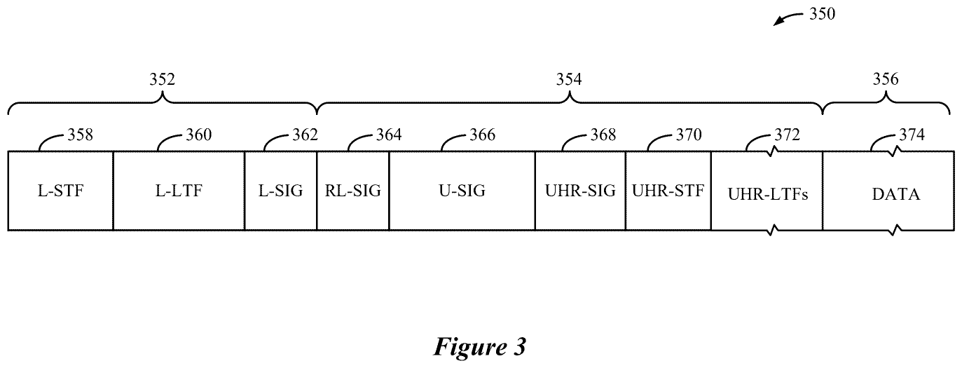

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field (referred to herein as “U-SIG 366”) and a UHR signal field (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field (referred to herein as “UHR-STF 370,” although it may be structured as, and carry version-dependent information for, other wireless communication protocol versions beyond UHR) and one or more additional long training fields (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHZ, 80 MHZ, 160 MHZ, and 320 MHz bandwidths supported by previous generations of IEEE-compliant wireless communication systems. For example, the PPDU 350 may support 480 MHz or 640 MHZ bandwidth communications. By increasing the channel bandwidth of the PPDU 350 to 480 MHz or 640 MHz, more data may be transmitted because more or larger RUs are available in accordance with the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some implementations, the spatial reuse fields may enable multiple BSSs to operate on the same 480 MHz or 640 MHz bandwidth channels.

In some implementations, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some implementations, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some implementations, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some implementations, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some implementations, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some implementations, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some implementations, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for decodability and fewer retransmissions. In some implementations, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some implementations, an ELR PPDU 350 may include an ELR-signature (ELR-SIG) field that includes an uplink/downlink indicator subfield, a length subfield, a coding indicator subfield, and a modulation and coding scheme (MCS) subfield.

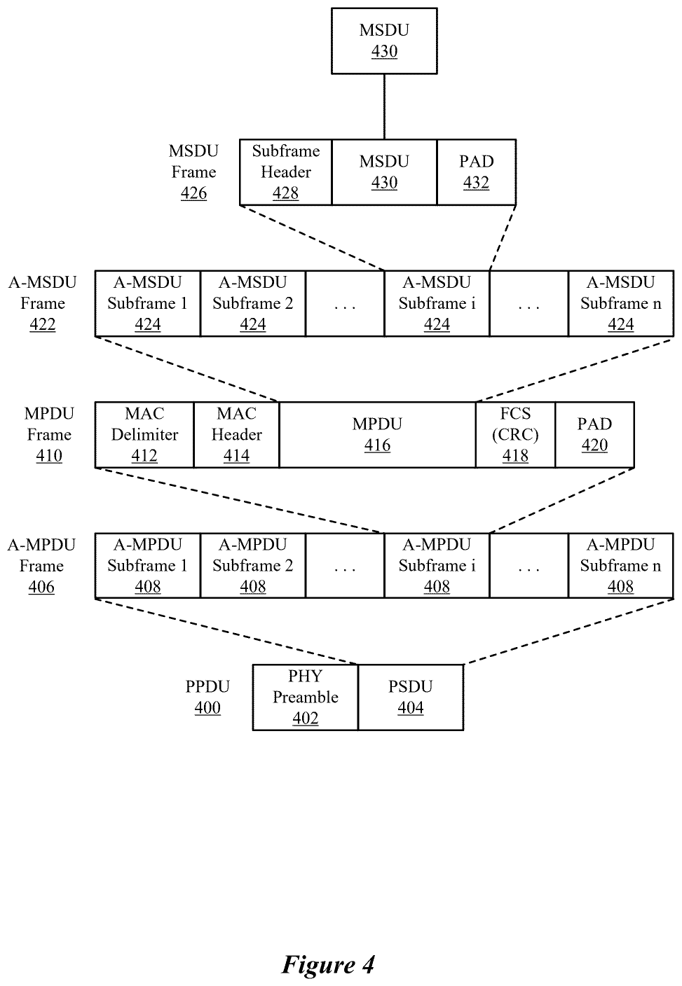

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, cither an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some implementations of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some implementations of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some implementations in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs in accordance with the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some implementations, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some implementations, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on CSI associated with the wireless channels over which the beamformer intends to communicate with the beamformec.

To obtain the CSI used for beamforming, the beamformer may perform a channel sounding procedure with the beamformee. For example, the beamformer may transmit one or more sounding signals (such as in the form of a null data packet (NDP)) to the beamformec. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some implementations, multiple APs 102 may simultaneously transmit signaling or communications to a single STA 104 utilizing a distributed MU-MIMO scheme.

Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHZ and the IEEE 802.11bn standard amendment supporting 480 MHz and 640 MHZ), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some implementations, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some implementations, MLO supports establishing multiple different communication links (such as a first link on the 2.4 GHz band, a second link on the 5 GHZ band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some implementations, the exchange of information may occur via a beacon frame, a probe request frame, a probe response frame, an association request frame, an association response frame, another management frame, a dedicated action frame, or an operating mode indicator (OMI), among other examples. In some implementations, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some implementations, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some implementations, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some implementations, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (cMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in implementations in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in implementations including a single BSS. For example, MLA may increase the number of users per multiplexed transmission served by the multi-link AP MLD.

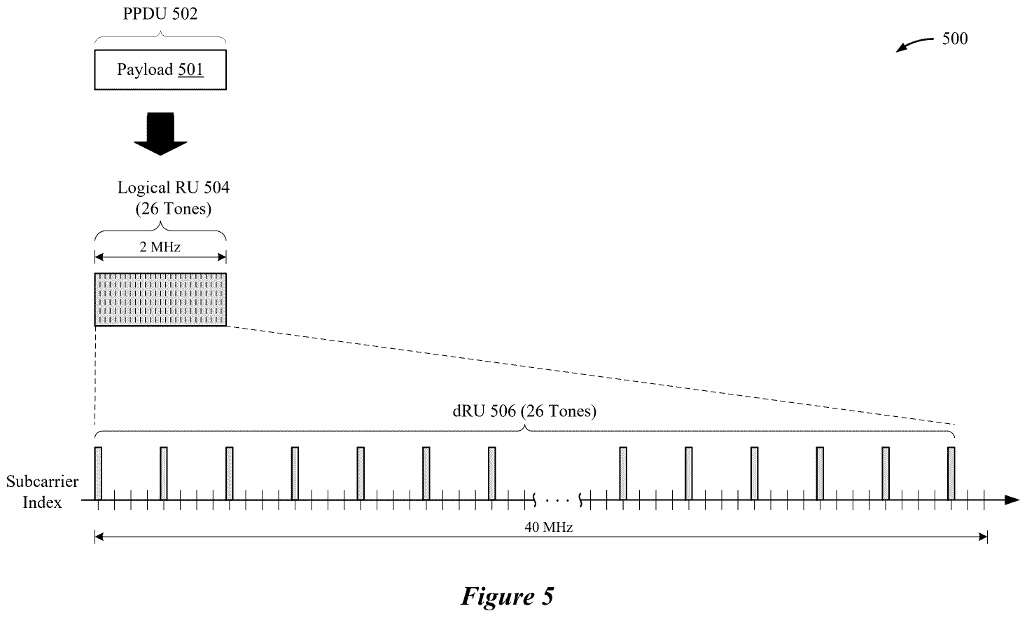

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent a regular RU (rRU) of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for PSD-limited wireless channels. For example, when mapped to an rRU such as logical RU 504, the transmit power of the logical RU 504 may be severely limited in accordance with the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504 is limited by the number of tones mapped to each 1 MHZ subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHZ wireless channel (also referred to herein as a “spreading bandwidth”). Compared to the tone mapping described above with respect to the legacy tone plan, the distributed tone mapping depicted in FIG. 5 effectively reduces the number of tones (of the logical RU 504) in each 1 MHz subchannel. For example, each of the 26 tones can be mapped to a different 1 MHZ subchannel of the 40 MHz channel. As a result, each AP 102 or STA 104 implementing the distributed tone mapping of FIG. 5 can maximize its per-tone transmit power (which may maximize the overall transmit power of the logical RU 504).

In some implementations (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some implementations, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform (IFFT)) for transmission over a wireless channel. The AP 102 may receive the time-domain signal and reconstruct the dRU 506 (such as by a fast Fourier transform (FFT)). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

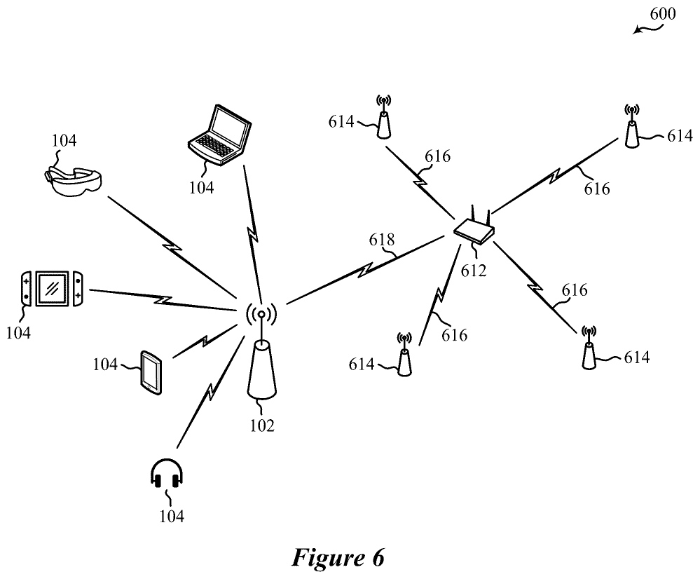

FIG. 6 shows a pictorial diagram of another example wireless communication network 600. According to some aspects, the wireless communication network 600 can be an example of a mesh network, an IoT network, or a sensor network in accordance with one or more of the IEEE 802.11 family of wireless communication protocol standards (including the 802.11ah amendment). The wireless communication network 600 may include multiple wireless communication devices 614, which in some implementations may include APs 102, STAs 104, or both. The wireless communication devices 614 may represent various devices such as display devices (such as TVs, computer monitors, navigation systems, among others), music or other audio or stereo devices, remote control devices (“remotes”), printers, kitchen or other household appliances, among other examples.

In some implementations, the wireless communication devices 614 sense, measure, collect or otherwise obtain and process data and transmit such raw or processed data to an intermediate device 612 for subsequent processing or distribution. Additionally, or alternatively, the intermediate device 612 may transmit control information, digital content (such as audio or video data), configuration information or other instructions to the wireless communication devices 614. The intermediate device 612 and the wireless communication devices 614 can communicate with one another via wireless communication links 616. In some implementations, the wireless communication links 616 include Bluetooth links or other PAN or short-range communication links.

In some implementations, the intermediate device 612 also may be configured for wireless communication with other networks such as with a WLAN or a wireless (such as cellular) wide area network (WWAN), which may, in turn, provide access to external networks including the Internet. For example, the intermediate device 612 may associate and communicate, over a Wi-Fi link 618, with an AP 102 of a wireless communication network 600, which also may serve various STAs 104. In some implementations, the intermediate device 612 is an example of a network gateway, for example, an IoT gateway. In such a manner, the intermediate device 612 may serve as an edge network bridge providing a Wi-Fi core backhaul for the IoT network including the wireless communication devices 614. In some implementations, the intermediate device 612 can analyze, preprocess and aggregate data received from the wireless communication devices 614 locally at the edge before transmitting it to other devices or external networks via the Wi-Fi link 618. The intermediate device 612 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

In some implementations, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

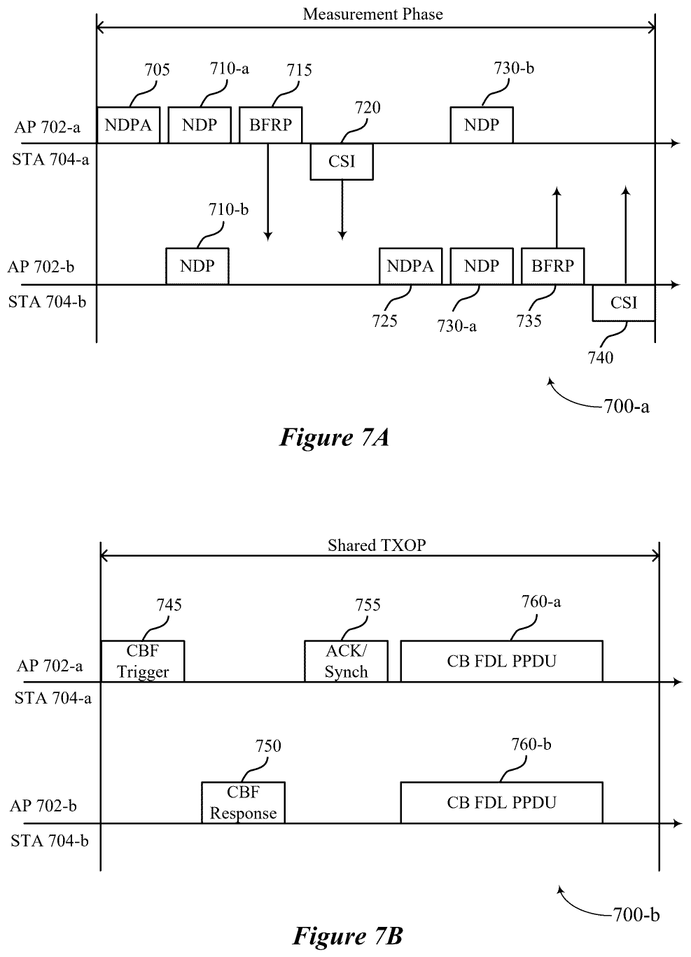

FIGS. 7A and 7B show examples of signaling diagrams 700 that support using a unified framework for coordinated transmission modes. The signaling diagrams 700 include an AP 702-a, and AP 702-b, a STA 704-a, and a STA 704-b. The AP 702-a and the AP 702-b may be examples of the APs as described herein with respect to FIGS. 1-6, and the STA 704-a and the STA 704-b may be examples of the STAs as described herein with respect to FIGS. 1-6. The signaling diagram 700-a illustrates example operations and signaling for a measurement phase of the unified transmission mode operation framework.

As described herein, the wireless communication devices may implement a framework for selection and utilization of a transmission mode from a CBF, CSR, or dedicated TXOP transmission mode. The transmission modes may be used to determine when and how to share resources with other APs and when not to share such resources. To determine whether to share resources in accordance with the CSR mode, clients (such as the STA 704-a and the STA 704-b) may be classified to one of two classes: inner clients and outer clients. Inner clients are clients that may be less exposed to interference from neighbor APs, and thus TXOPs may be shared when the TXOPs are scheduled. For example, if STA 704-b is relatively unimpacted from interference from communications by AP 702-a with STA 704-a, the STA 704-b may be classified as an inner client with respect to the AP 702-a. An outer client is a client that may be vulnerable to interference from neighbor APs, and thus TXOPs may not be shared when scheduled.

For CSR, inner or outer client classification may be done offline or on-the-fly. In accordance with the offline classification, the AP (such as AP 702-a) may request associated clients to send reports about received powers of beacon signals (or other signals) transmitted by other APs (such as AP 702-b). In such scenarios, a beacon frame may be transmitted, but other frames with known or fixed transmission powers may be used for measurement as well. In accordance with on-the-fly classifications, the APs (such as AP 702-a and AP 702-b) may perform an initial control frame (ICF) and initial control response (ICR) frame exchange with associated clients scheduled in a current TXOP and share the receive power information between the sharing AP and the shared AP such that the sharing AP is able to obtain an estimate of the shared AP's interference level at the scheduled client (such as STA 704-b). The estimation may be indicative of a STA's (such as STA 704-b) relative isolation (such as geographic isolation) from the other AP (such as AP 702-a), which may inform inter-BSS interference levels.

Contrary to CSR, CBF may not rely on isolation to ensure low inter-BSS interference. Rather, the CBF transmission mode may utilize the APs' (such as AP 702-a and 702-b) hardware capabilities (such as larger antenna arrays) to actively null (such as attenuate) signals to OBSSs' clients using transmit beamforming. This signal nulling (beamforming) technique may be dependent on measurement information obtained by the transmitters (such as the AP 702-a and the AP 702-b). For example, the AP 702-a may obtain a channel estimate for a channel between the AP 702-a and the STA 704-a served by the AP 702-a and a channel estimate for a channel between the AP 702-a and the STA 704-b served by the AP 702-b. To facilitate the exchange of information, the AP 702-a and the AP 702-b may perform joint sounding, as illustrated in the signaling diagram 700-a. If the AP 702-a and the AP 702-b coordinate a TXOP for communications with the STA 704-a and the STA 704-b, the AP 702-a and the AP 702-b may perform a transmission phase that includes a CBF trigger frame, CBF response, an acknowledgment (ACK)/synchronization frame exchange (ACK/SYNC). Additionally, the AP 702-a and the AP 702-b may perform respective DL PPDU transmissions and receive block acknowledgments during the coordinated transmission opportunity.

To facilitate the CSR-CBF operation framework described herein, the CSR and CBF signaling similarities may be identified. The offline variant of the CSR signaling sequence may be an example of or similar to a subset of the CBF signaling. For example, a beamforming report poll trigger frame (BFRP) and measurement frames (such as CSI frames) exchanged between each AP and a respective client may be utilized to report interference levels experienced by the client from the neighboring AP. For example, the BFRP frame may be used to solicit feedback from multiple STAs, and the CSI frame may be used to provide measurements. The measurements may be received or decoded by serving and non-serving APs. In accordance with the measurement levels (such as OBSS AP RSSI) reported with the CSI, the sharing AP or the shared AP may determine which transmission mode (such as CBF, CSR, or dedicated TXOP) to use for communications. For example, symmetric CBF may be dependent on both the AP 702-a and the 702-b being able to null the respective signals at the clients scheduled by the other AP. CSR may be dependent on clients scheduled by both the AP 702-a and the AP 702-b being inner clients with a possibility of transmission power adjustment at the shared access point. Asymmetric CBF may be dependent on the shared AP being able to null (attenuate) a signal at the sharing AP's scheduled clients. No TXOP sharing (such as dedicated TXOP) may be used if the symmetric CBF, asymmetric CBF, or CSR transmission mode is not selected. These techniques may be applicable in a downlink-downlink (DL-DL) scenario (where both the AP 702-a and the AP 702-b are performing DL communications during the PPDU frame).

To facilitate the exchange of measurement information to support the CSR-CBF operation framework described herein, the AP 702-a, the AP 702-b, the STA 704-a, and the STA 704-b may implement the measurement phase illustrated in signaling diagram 700-a. The measurement phase of the signaling diagram 700-a also may be referred to as a channel sounding phase, and the sounding sequence of the signaling diagram 700-a may follow the CBF sounding sequence. That is, the AP 702-a may transmit a null data packet announcement (NDPA) 705. In response to the NDPA 705, and the AP 702-a may transmit an NDP 710-a, and the AP 702-b may transmit a NDP 710-b. The NDP 710-a and the NDP 710-b may be transmitted using different resources (such as different time-domain resources). The STA 704-a may measure the NDP 710-a transmitted by the AP 702-a and the NDP 710-b transmitted by AP 702-b. The AP may transmit a beamforming report poll (BFRP) frame 715.

The STA 704-a may transmit channel measurement information 720 (such as CSI frame) associated with the measurements of the NDP 710-a and the NDP 710-b. For example, the channel measurement information transmitted by the STA 704-a includes information such as a CSI report for measurements of a transmission by the AP 702-a (In-BSS CSI), RSSI for measurements of the transmission by the AP 702-a (signal strength), a CSI report for measurements of a transmission by the AP 702-b (OBSS CSI), and RSSI for measurements of a transmission by the AP 702-b (interference strength). To facilitate the CSR-CBF operation framework described herein, the BFRP frame 715 and the measurement information is received and decoded by the AP 702-b. Further, for the served STA 704-a, the AP 702-a may utilize the in-BSS CSI, the signal strength, and the interference strength received from the STA 704-a for determining whether to use CBF or CSR. However, in some scenarios, the CSI frames (such as the channel measurement information 720) may not be received at an adequate signal-to-noise ratio and successfully decoded by the AP 702-b. Therefore, for some OBSS clients, the AP 702-a and the AP 702-b may not be able to successfully acquire CSI information and hence may not be able to null interference or attenuate signals to reduce or limit potential interference.

A similar sounding technique is used by the AP 702-b and the STA 704-b. For example, the AP 702-b transmits an NDPA 725, an NDP 730-a, and a BFRP 735. The AP 702-a may transmit an NDP 730-b in response to the NDPA 725. The STA 704-b may measure transmissions by the AP 702-b and the AP 702-a, and transmit channel measurement information 740. The channel measurement information 740 may be received and decoded by both the AP 702-b and the AP 702-a. The measurement information transmitted by the STA 704-b may include information such as a CSI report for measurements of a transmission by the AP 702-b (in-BSS CSI), RSSI for measurements of the transmission by the AP 702-b (signal strength), a CSI report for measurements of a transmission by the AP 702-a, (OBSS CSI), and RSSI for measurements of the transmission by the AP 702-b (interference strength). To facilitate the CSR-CBF operation framework, the AP 702-a may utilize the OBSS CSI and the interference strength received from the STA 704-b.

The signaling diagram 700-b illustrates example operations for a CBF transmission mode. To trigger the CBF transmission mode, the sharing AP 702-a may transmit a CBF trigger frame 745, and the CBF trigger frame may include various information such as synchronization information and an identifier of the STA 704-a to be scheduled during the TXOP. The shared AP 702-b may transmit a CBF response 750 indicating that the shared AP 702-b intends to participate in the CBF mode and indicating an identifier associated with the STA 704-b that is to be scheduled during the transmission opportunity. The sharing AP 702-a may transmit an acknowledgement/sync frame 755 that indicates that the sharing AP acknowledges the CBF response 750. The acknowledgement/sync frame 755 also may include additional synchronization information that is to be used in the respective CBF DL PPDUs 760-a and 760-b. For example, the AP 702-a use the synchronization information to transmit one or more downlink messages to the STA 704-a during the CBF DL PPDU 760-a, and the AP 702-b may utilize the synchronization information to transmit one or more downlink messages to the STA 704-b during the CBF DL PPDU 760-b.

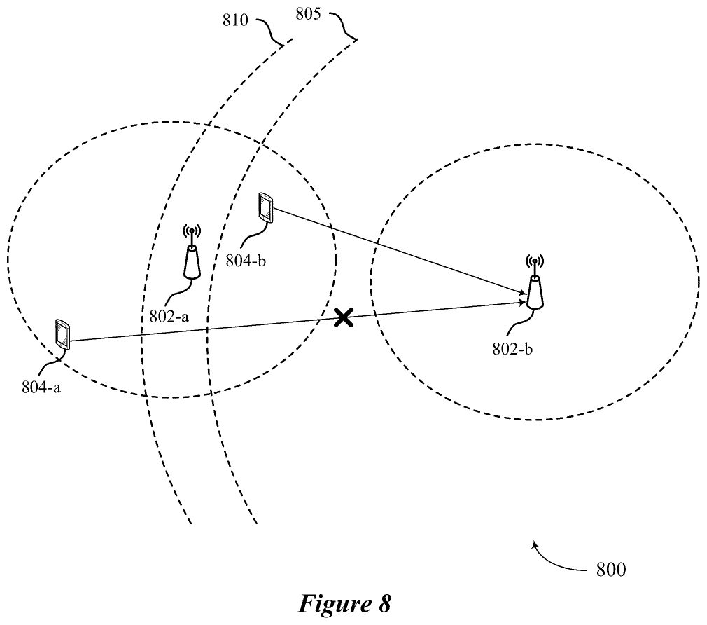

FIG. 8 shows an example of a wireless communications system 800 that supports using a unified framework for coordinated transmission modes. The wireless communications system 800 may include an AP 802-a, an AP 702-b, a STA 704-a, and a STA 704-b. The AP 702-a and the AP 702-b may be examples of the APs as described herein with respect to FIGS. 1-7, and the STA 704-a and the STA 704-b may be examples of the STAs as described herein with respect to FIGS. 1-7.

As illustrated in FIG. 8, the STA 804-b that is associated with AP 802-a may be located within a first hearing range 805 of the AP 802-b, and the first hearing range 805 may be associated with a transmit power of the STA 804-a and the STA 804-b. Additionally, the STA 804-a is located outside the first hearing range 805 and a second hearing range 810 of the AP 802-b. The second hearing range may be associated with a transmission power of the AP 802-a. The hearing range 805 and the hearing range 810 may be dependent on various factors including an inter-AP distance (such as distance between the AP 802-a and the AP 802-b), the transmission power of the STA 804-a and the STA 804-b, among other factors. Therefore, the CSI frames (such as channel measurement information 720 of FIG. 7A) sent by some clients that are associated with a specific AP may not be decodable by other APs. For example, the AP 802-b may receive and decode the CSI information transmitted by the STA 804-b, but the AP 802-b may not decode the CSI information transmitted by the STA 804-a. In such scenarios, one of the APs 802 may not have complete CSI information, and the CBF mode may not be used for scheduling the STA 804-a.

Therefore, as described in further detail herein, each AP 802 may classify the respective clients as inner (in accordance with the low reported OBSS RSSI, which also implies that the CSI may have not been successfully decoded by OBSS AP) or outer (in accordance with the high reported OBSS RSSI, which also implies that the CSI may have been decoded successfully by OBSS AP) so that the APs 802 may coordinate and choose an appropriate transmission scheme (such as a transmission mode). Client (such as the STA 804-a) classification may be performed per STA 804-a and STA 804-b with respect to each other AP 802, and client classification may be performed by the associated AP 802 for the CSR mode (and possibly/optionally the OBSS AP 802 for the CBF mode). For CSR mode, the AP 802-a may classify the STA 804-a and the STA 804-b as inner or outer with respect to the AP 802-b.

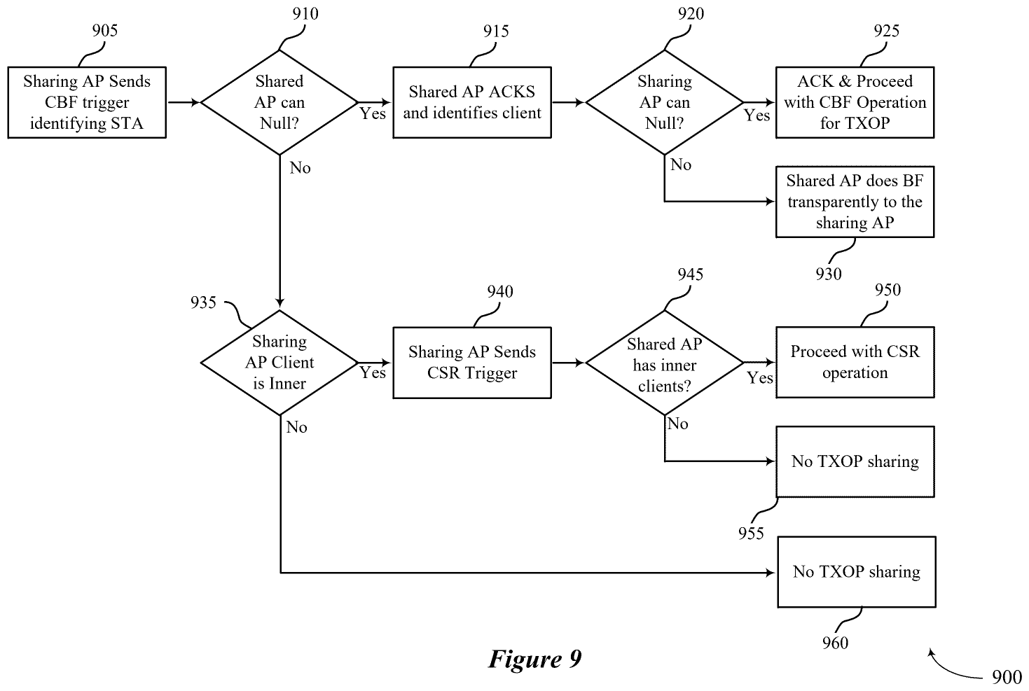

FIG. 9 shows an example of an operation framework 900 that supports using a unified framework for coordinated transmission modes. The operation framework 900 may be implemented by wireless communications devices described herein, such as the APs and STAs described herein with respect to FIGS. 1-8. The operation framework 900 illustrates example operations and decisions for selection and utilization of a transmission mode from a CBF transmission mode, a CSR transmission mode, or a dedicated transmission opportunity transmission mode.

The operation framework 900 may be implemented under the assumption that a measurement phase (such as the measurement phase of FIG. 7A) has been performed between a first and second AP. The operation framework 900 may be triggered by a sharing AP (such as an AP that intends to share resources of a transmission opportunity with a shared AP) to schedule communications with one or more STAs associated with the sharing AP. At 905, the sharing AP may transmit a coordinated trigger request frame, such as a coordinated beamforming frame, that identifies at least one STA associated with the sharing AP.

The coordinated trigger request frame may indicate that the sharing AP is able or willing to share a TXOP with the shared AP using a coordinated transmission mode (such as a CBF transmission mode) between the sharing AP and the shared AP. In other words, the coordinated trigger request frame may serve, operate, function, or be transmitted as an invitation to the shared AP, inviting the shared AP to communicate with one or more STAs associated with the shared AP during the TXOP using the coordinated transmission mode.

At 910, the shared AP may determine whether the shared AP can attenuate a transmit signal (such as at one or more STAs associated with the sharing AP) such as to mitigate or limit interference for communications between the sharing AP and the one or more first STAs associated with the sharing AP during a coordinated TXOP. In some implementations, the shared AP evaluates whether the shared AP can attenuate the transmit signal (such as transmit a null signal) using information obtained during the measurement phase performed between the sharing AP and the shared AP. For example, the measurements received from the one or more first STAs may be indicative of whether the shared AP can attenuate the transmit signal. Additionally, or alternatively, as described herein, the shared AP may be unable to receive or decode the measurement information transmitted by the one or more first STAs associated with the sharing AP. In such scenarios, the shared AP may not be able transmit the null signal due to lack of measurement information.

The shared AP may transmit a response, to the trigger frame, that indicates whether the shared AP is to participate in the TXOP sharing via a coordinated transmission mode (such as via an ACK/NACK). By way of example, the response may indicate whether the shared AP can attenuate the transmit signal. For example, at 915, the shared AP may transmit an ACK (such as via a CBF Trigger Response frame) with an indication of one or more second STAs to be scheduled by the shared AP during the transmission opportunity. After receiving the response to the trigger frame, the sharing AP and the shared AP may communicate in accordance with one or more of the transmission modes. Communication may include exchanging additional coordination frames between the sharing and shared APs (such as another response, coordination information, ACK/sync frames), transmitting one or more downlink messages to respective STAs during the TXOP (during the PPDU frames), or receiving BA responses from the respective STAs. Thus, communication by the sharing and shared APs (after response) may include transmitting and receiving communications from the other APs and transmitting and receiving communications from the respective STAs.

At 920, the sharing AP may evaluate whether the sharing AP can attenuate a second transmit signal associated with communications between the shared AP and the one or more second STAs, such as to mitigate or limit interference between communications between the shared AP and the one or more second STAs. The evaluation by the sharing AP may be based on the measurements received during the measurement phase. If the sharing AP can transmit the second mitigation signal, at 925, the sharing AP may transmit an ACK (response to the ACK transmitted by the shared AP) and proceed with the symmetric CBF operation. If the sharing AP cannot attenuate the signal, at 930, the shared AP may perform BF transparently to the sharing AP. That is, the sharing and shared AP may communicate in accordance with an asymmetric CBF transmission mode.

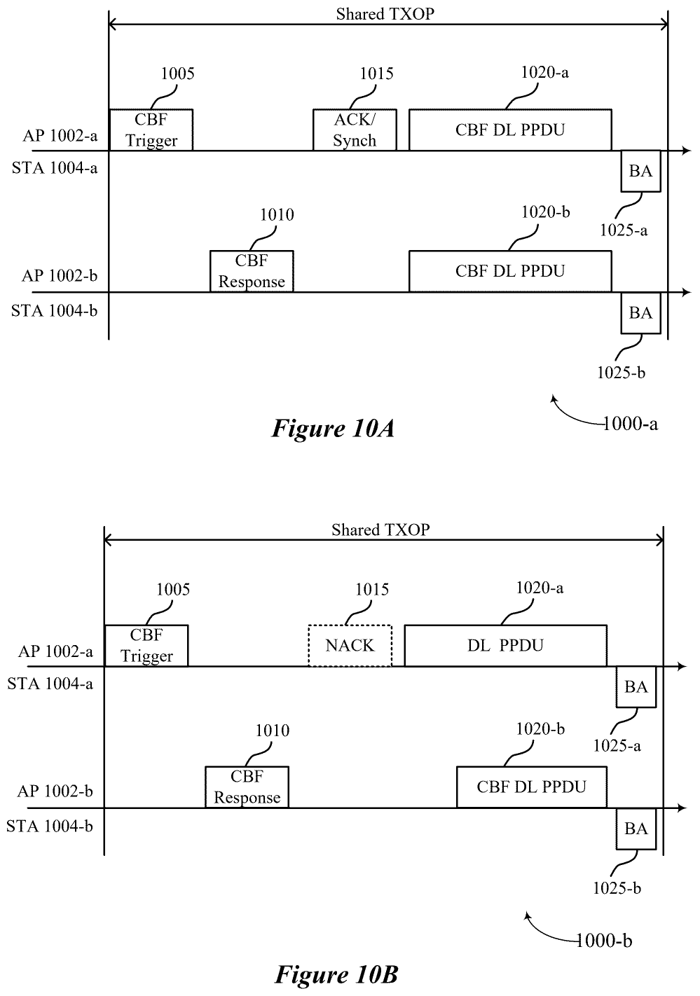

If the shared AP cannot null (transmits a NACK), at 935, the sharing AP may evaluate whether the one or more first STAs associated with the sharing AP are classified as inner clients (such as whether the STAs are subject to interference from communications by the second AP). The evaluations may utilize the measurement information received from the one or more first STAs. If the one or more first clients are inner clients, at 940, the sharing AP may transmit a CSR trigger frame, and the CSR trigger frame may include synchronization information for coordinating resources of the transmission opportunity. At 945, in response to the CSR trigger, the shared AP may evaluate whether the one or more second STAs are classified as inner clients (such as whether the one or more second STAs are subject to interference by communications by the first AP). If the shared AP has inner clients, at 950, the sharing and shared APs may proceed with communications with the respective STAs during the TXOP in accordance with the synchronization information transmitted via the CSR trigger frame. If the shared AP does not have inner clients ready to be scheduled during the shared TXOP (such as the shared AP has outer clients), the sharing AP may proceed with communications in accordance with the CSR mode (at 955), but the shared AP may not participate. As a result, the sharing AP is using a dedicated (such as unshared) TXOP for communications with the one or more first STAs. If, at 935, the sharing AP determines that the one or more first STAs are outer clients, at 960, the sharing AP may proceed with communicating with the one or more first STAs in accordance with a dedicated TXOP mode (no TXOP sharing). The various signaling to support the operation framework 900 are described herein with reference to FIGS. 10A-12.

FIGS. 10A and 10B show examples of signaling diagrams 1000 that support using a unified framework for coordinated transmission modes. The signaling diagrams 1000 may be implemented by an AP 1002-a, an AP 1002-b, a STA 1004-a, and a STA 1004-b. The AP 1002-a and the AP 1002-b may be examples of the APs as described herein with reference to FIGS. 1-9, and the STA 1004-a and the STA 1004-b, may be examples of the STAs as described herein with reference to FIGS. 1-9.

The signaling diagram 1000-a illustrates example operations for the unified CSR-CBF operation framework that results in symmetric CBF. At 1005, the AP 1002-a (sharing AP) may transmit a coordinated trigger request frame (such as CBF trigger frame) to the AP 1002-b. The coordinated trigger request frame may be indicative of the intent to share a TXOP and operate in accordance with the CBF mode and one or more clients (such as STA 1004-a) that are to be scheduled for communications with the AP 1002-a in the TXOP. The coordinated trigger request frame also may include information used for a common preamble for the potential CBF DL PPDU frames used for communicating with the STA 1004-a by the AP 1002-a and with the STA 1004-b by the AP 1002-b in accordance with the CBF mode. The information may include per user information of the scheduled clients in the sharing BSS, such as a Number of Spatial Streams (NSS; for example, the information may indicate an NSS for each STA of one or more STAs that are scheduled or schedulable by the AP 1002-a within the TXOP). The information also may include common information, such as lower density parity check (LDPC) extra symbol segments, packet extension PE disambiguity information, and legacy signal (L-SIG) length, among other information.

At 1010, the AP 1002-b may transmit, to the AP 1002-a, a response (such as BF response frame). The response may include an indication of whether the AP 1002-b may contribute in the CBF transmission, whether the AP 1002-b is able to attenuate (null) a signal at the sharing AP's clients (such as the STA 1004-a), or one or more identifiers for one or more clients (such as STA 1004-b) to be scheduled in the current TXOP. The response may additionally include information for common preamble of the CBF DL PPDU frames, which may be referred to as preamble information. The common preamble information may include user-specific information such as NSS (for example, the response may indicate an NSS for each STA of one or more STAs that are scheduled or schedulable by the AP 1002-b within the TXOP) or common information such as the LDPC extra symbol segments, PE disambiguity information, L-SIG length, among other information.

At 1015, in scenarios when the response indicates that the AP 1002-b is able to null the signal (such as transmit the mitigation signal), the sharing AP 1002-a may transmit a second response (such as an ACK/synch frame) at 1015. The second response may include an indication of whether the AP 1002-a is able to null the signal (such as transmit a mitigation signal) of the AP 1002-a at the STA 1004-a of the shared AP. The response also may include common preamble information for the CBF DL PPDU frames and parameters for time/frequency synchronization for CBF (such as user-specific information such as NSS or common information such as LDPC extra symbol segments, PE disambiguity information, L-SIG length). At 1020, the synchronized CBF DL PPDU frames are transmitted, and the sequence may conclude with respective BA responses at 1025-a and 102-b in a synchronized manner. For example, at 1020-a the AP 1002-a may transmit one or more downlink messages to the STA 1004-a, and at 1020-b, the AP 1002-b may transmit one or more downlink messages to the STA 1004-b. The STA 1004-a may transmit the BA at 102-5a, and the STA 1004-b may transmit the BA at 1025-b.

The signaling diagram 1000-b illustrates example operations for the unified CSR-CBF operation framework that results in asymmetric CBF. Operations at 1005 and 1010 of signaling diagram 1000-a may be similar to the operations at 1005- and 1010 of signaling diagram 1000-a. The response at 1010 may indicate that the AP 1002-b is able to transmit the mitigation signal for communications between the AP 1002-a and the STA 1004-a.

At 1015, in scenarios when the response indicates that the AP 1002-b is able to attenuate the signal, the sharing AP 1002-a may evaluate whether the sharing AP 1002-a can attenuate a transmit signal associated with communications between the AP 1002-a and the STA 1004-a at the STA 1004-b (in accordance with the response including an identifier for the STA 1004-b), such as to limit or mitigate interference for communications between the AP 1002-b and the STA 1004-b. In the example of the signaling diagram 1000-b, the sharing AP cannot attenuate the signal at the STA 1004-b. As such, the sharing AP 1002-a may proceed with a DL PPDU at 102-a. In some implementations, the sharing AP 1002-a may indicate the inability to transmit the mitigation signal via a NACK and second response at 1015. The shared AP 1002-b may continue the BF DL PPDU at 1020-b, and the beamformed PPDU may be sent to the STA 1004-b transparently to the STA 1004-a. BA responses at 1025 may be transmitted in a synchronized manner. Additionally, or alternatively, the shared AP 1002-b may use a non-immediate ACK policy and poll for the BA at 1025-b at a later time (such as at least an offset duration after the DL PPDU at 1020-b). In some implementations, the asymmetric CBF PPDUs at 1020 may be synchronous. Additionally, or alternatively, the DL PPDUs at 1020 are asynchronous for asymmetric CBF. The signaling diagram 1000-b illustrates the asynchronous example. In a synchronous asymmetric CBF, the DL PPDUs at 1020 may be aligned and share a common legacy preamble.

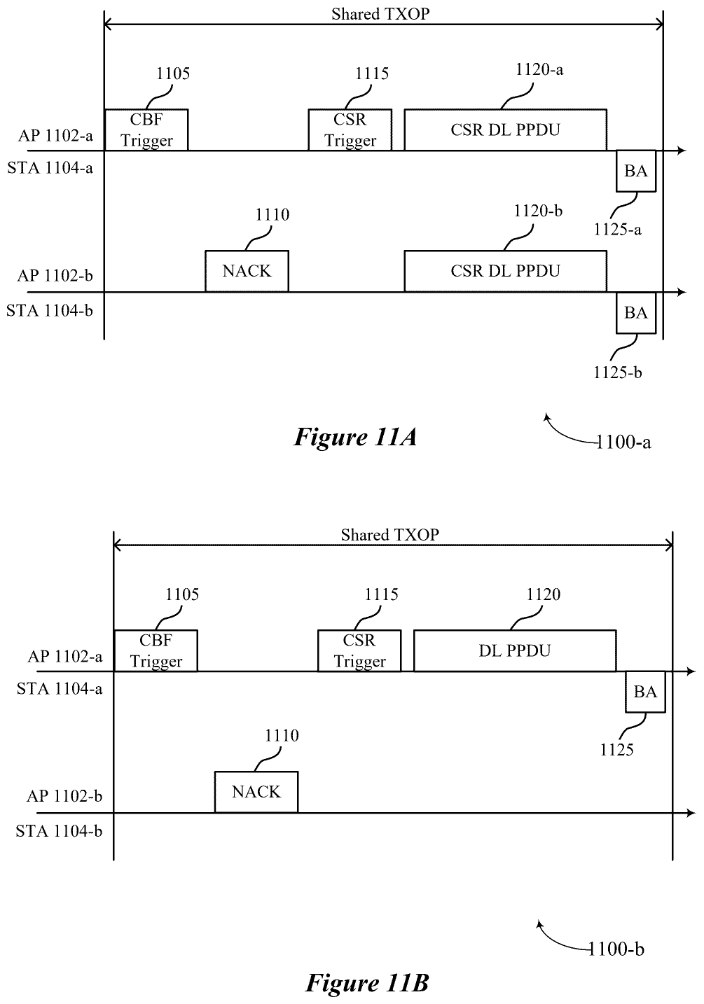

FIGS. 11A and 11B show examples of signaling diagrams 1100 that support using a unified framework for coordinated transmission modes. The signaling diagrams 1100 may be implemented by an AP 1102-a, an AP 1102-b, a STA 1104-a, and a STA 1104-b. The AP 1102-a and the AP 1102-b may be examples of the APs as described herein with reference to FIGS. 1-10, and the STA 1104-a and the STA 1104-b, may be examples of the STAs as described herein with reference to FIGS. 1-10.

The signaling diagram 1100-a illustrates example operations for the unified CSR-CBF operation framework that results in utilization of the CSR mode. At 1105, the AP 1102-a (sharing AP) may transmit a coordinated trigger request frame (such as CBF trigger frame) to the AP 1102-b. The coordinated trigger request frame may be indicative of the intent to share a TXOP and operate in accordance with the CBF mode and one or more clients (such as STA 1104-a) that are to be scheduled for communications with the AP 1102-a in the TXOP.

The coordinated trigger request frame may indicate that the AP 1102-a is able or willing to share a TXOP with the AP 1102-b using a coordinated transmission mode (such as the CBF mode) between the AP 1102-a and the AP 1102-b. In other words, the coordinated trigger request frame may serve, operate, function, or be transmitted as an invitation to the AP 1102-b, inviting the AP 1102-b to communicate with one or more STAs associated with the AP 1102-b during the TXOP using the coordinated transmission mode.

The coordinated trigger request frame also may include information that may be used for a common preamble for a potential CBF DL PPDU frames used for communicating with the STA 1104-a and the STA 1104-b by the AP 1102-a and the AP 1102-b, respectively.

At 1110, the AP 1102-b may transmit, to the AP 1102-a, a response (such as CBF response frame). The response may include an indication that the AP 1102-b is not to contribute to a CBF transmission (NACK). By way of example, the AP 1102-b may transmit the response including an indication that the AP 1102-b cannot attenuate a transmit signal associated with the communications between the AP 1102-b and the STA 1104-b at the STA 1104-a (such as to mitigate or limit interference for communications between the AP 1102-a and the STA 1104-a). As a result of the NACK, the sharing AP 1002-a may attempt to utilize the CSR transmission mode by transmitting a CSR trigger frame at 1115 (such as a second response). The CSR trigger frame may include an indication that the AP 1102-a is intending to operate in accordance with the CSR transmission mode, and information used for the CSR operation, such as allowed shared AP 1102-b transmission power, PPDU start time, PPDU duration, among other information. At 1120-a and 1120-b, the synchronized CSR DL PPDUS may be used for communications with the STA 1104-a and the STA 1104-b. The sequence may conclude with BA responses at 1125-a and 1125-b in a synchronized manner.

The signaling diagram 1100-b illustrates example operations for the unified CSR-CBF operation framework that results in no TXOP sharing (such as a dedicated TXOP). Operations at 1105 to 1115 of the signaling diagram 1000-b may be similar to operations at 1105 to 1115 of signaling diagram 1000-a. However, after transmission of the CSR trigger frame at 1115 by the sharing AP 1102-a, the shared AP 1102-b may have no inner clients with pending traffic, and thus cannot operate in the CSR mode. In such scenarios, at 1120, the sharing AP 1102-a may proceed with a normal DL PPDU transmission followed by the BA response at 1125. In such scenarios, the TXOP may not be shared between the sharing AP 1102-a and the shared AP 1102-b.

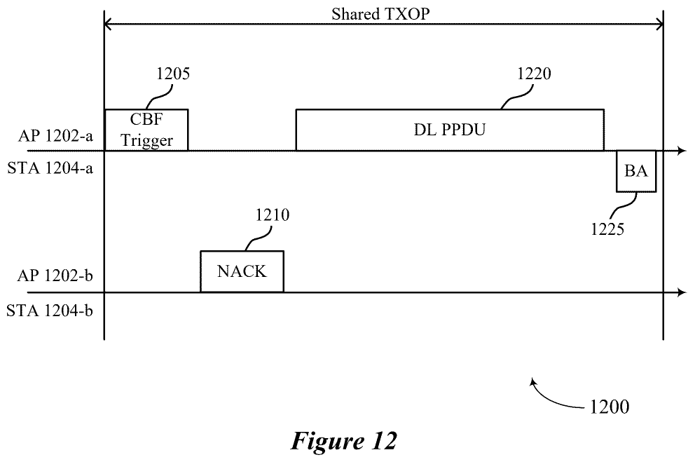

FIG. 12 shows an example of a signaling diagram 1200 that supports using a unified framework for coordinated transmission modes. The signaling diagram 1200 may be implemented by an AP 1202-a, an AP 1202-b, a STA 1204-a, and a STA 1204-b. The AP 1202-a and the AP 1202-b may be examples of the APs as described herein with reference to FIGS. 1-11, and the STA 1204-a and the STA 1204-b, may be examples of the STAs as described herein with reference to FIGS. 1-11.

The signaling diagram 1200 illustrates example operations for the unified CSR-CBF operation framework that results in utilization of the dedicated TXOP transmission mode (such as no TXOP sharing with another AP). At 1205, the AP 1202-a (sharing AP) may transmit a coordinated trigger request frame (such as CBF trigger frame) to the AP 1202-b. The coordinated trigger request frame may be indicative of the intent to share a TXOP and operate in accordance with the CBF mode, one or more clients (such as STA 1204-a) that are to be scheduled for communications with the AP 1202-a in the TXOP, and information that may be used for a common preamble for a potential CBF DL PPDU frames used for communicating with the STA 1204-a and the STA 1204-b by the AP 1202-a and the AP 1202-b, respectively.

At 1210, the AP 1202-b may transmit, to the AP 1202-a, a response (such as CBF response frame). The response may include an indication that the AP 1202-b is not to contribute to a CBF transmission (NACK), such as an indication that the AP 1202-b cannot attenuate a transmit signal for the communications between the AP 1202-b and the STA 1204-b at the STA 1204-a (such as to mitigate or limit interference for communications between the AP 1102-a and the STA 1104-a). As a result of the NACK, the sharing AP 1002-a may explore the CSR transmission mode but may determine that the STA 1204-a is not an inner client (such as is an outer client) and decides not to share the TXOP. The determination may be in accordance with the assumption that inner clients may be scheduled by their own associated APs 1202 (such as STA 1204-a scheduled by AP 1202-a) to operate in the CSR, and that inner clients may be difficult for the OBSS AP (such as the AP 1202-b) to receive the CSI information by decoding the CSI frame sent during the measurement phase. Additionally, the determination may be in accordance with the assumption that outer clients cannot be scheduled by their own associated AP to operate in the CSR mode and are casier for the OBSS AP (such as AP 1202-b) to receive the CSI information by decoding the CSI frame sent within the measurement phase. However, CSI frames of outer clients may be missed for various reasons, such as error bursts, making the outer clients ineligible for CBF due to lack of CSI information at the OBSS AP in addition or alternatively to being ineligible for CSR due to high interference (such as due to closeness to the OBSS AP). As such, at 1220, the sharing AP 1202-a may proceed with a DL PPDU transmission in accordance with the dedicated TXOP sharing mode followed by a BA response at 1225.

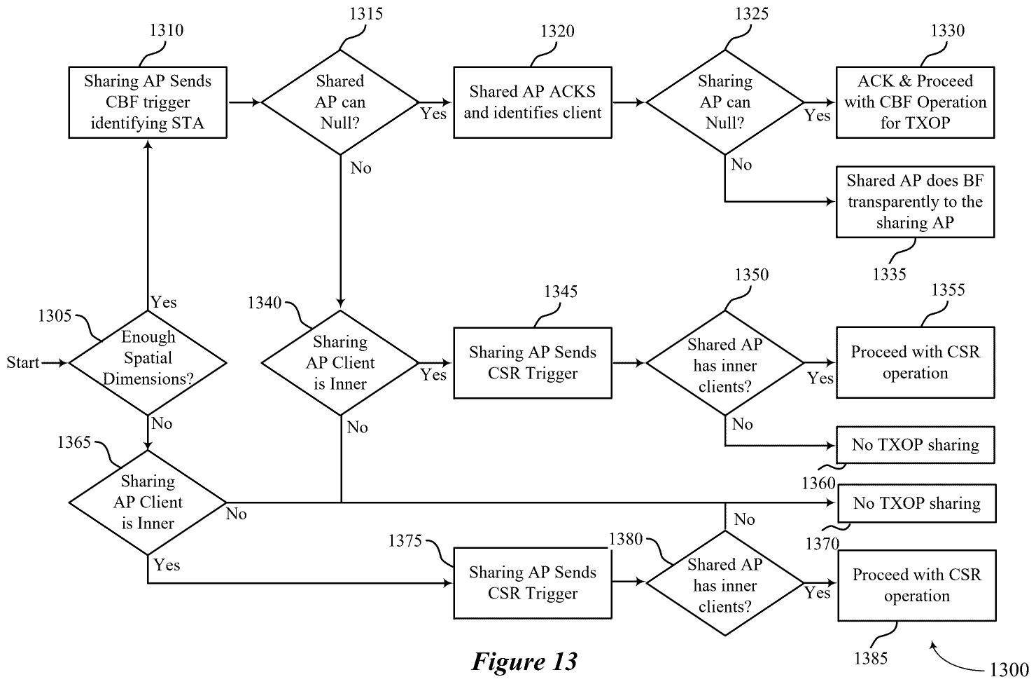

FIG. 13 shows an example of an operation framework 1300 that supports using a unified framework for coordinated transmission modes. The operation framework 1300 may be implemented by wireless communications devices described herein, such as the APs and STAs described herein with respect to FIGS. 1-12. The operation framework 1300 illustrates example operations and decisions for selection and utilization of a transmission mode from a CBF transmission mode, a CSR transmission mode, or a dedicated transmission opportunity transmission mode.

The operation framework 1300 is an extended framework relative to the operation framework 900 of FIG. 9. The operation framework 1300 includes a possibility of starting with a CSR operation mode (instead of the CBF mode). This option may be used if the sharing AP does not have enough spatial dimensions to support a CBF operation mode. This scenario may occur, for example, when the sharing AP is performing MU-MIMO transmissions with multiple clients that consume a number of spatial degrees of freedom. The CSR operation mode may be equivalently referred to herein as a CSR mode or a CSR transmission mode. The CBF operation mode may be equivalently referred to herein as a CBF mode or a CBF transmission mode.

At 1305, the sharing AP may evaluate whether the sharing AP has enough spatial dimensions (such as quantity above a threshold) to support the CBF operation mode. The threshold quantity of spatial dimensions may be dependent on a quantity of STAs associated with the sharing AP allowed to be scheduled by the shared AP, the number of spatial streams to be used in accordance with communications between the shared AP and the STAs it schedules within the shared TXOP, and possibly the number of spatial streams to be transmitted by the shared AP to its associated clients. If the sharing AP determines that the sharing AP can support CBF operation mode, at 1310, the sharing AP may transmit a coordinated trigger request frame, such as a coordinated beamforming frame, that identifies at least one STA associated with the sharing AP. At 1315, the shared AP determines whether the shared AP can attenuate a transmit signal such as to mitigate or limit interference for communications between the sharing AP and the one or more first STAs associated with the sharing AP. In some implementations, the shared AP evaluates whether the shared AP can attenuate a transmit signal at the one or more first stations associated with the sharing AP in accordance with the measurement phase performed between the sharing AP and the shared AP. For example, the measurements received from the one or more first STAs may be indicative of whether the shared AP can attenuate the transmit signal. Additionally, or alternatively, as described herein, the shared AP may be unable to receive or decode the measurement information transmitted by the one or more first STAs associated with the sharing AP. In such scenarios, the shared AP may not be able to attenuate the signal due to lack of measurement information. Additionally, or alternatively, the shared AP may not be able to attenuate the signal due to having scheduled transmissions or conflicts during the TXOP that is to be shared by the sharing AP.

The shared AP may transmit a response, to the trigger frame, that indicates whether (such as ACK/NACK) the shared AP can attenuate the transmit signal. For example, at 1320, the shared AP may transmit an ACK (such as via an ACK/sync frame) with an indication of one or more second STAs to be scheduled by the shared AP during the transmission opportunity. At 1325, the sharing AP may evaluate whether the sharing AP can attenuate a second transmit signal associated with communications between the sharing AP and the one or more first STAs at the one or more second STAs such as to mitigate or limit interference between communications between the shared AP and the one or more second STAs. If the sharing AP can attenuate the signal, at 1330, the sharing AP may transmit an ACK (response to the ACK transmitted by the shared AP) and proceed with the CBF operation. If the sharing AP cannot attenuate the transmit signal, at 1335, the shared AP may perform BF transparently to the sharing AP. That is, the sharing and shared AP may communicate in accordance with an asymmetric CBF transmission mode.

If the shared AP cannot null (such as transmits a NACK), the sharing AP may evaluate whether the one or more first STAs associated with the sharing AP are classified as inner clients (such as whether the STAs are subject to interference from communications by the second AP). The evaluations may use the measurement information received from the one or more first STAs. If the one or more first clients are inner clients, the sharing AP may, at 1345, transmit a CSR trigger frame, and the CSR trigger frame may include synchronization information for coordinating resources of the transmission opportunity. At 1350, in response to the CSR trigger, the shared AP may evaluate whether the one or more second STAs are classified as inner clients (such as whether the one or more second STAs are subject to interference by communications by the first AP). If the shared AP has inner clients, at 1355, the sharing and shared APs may proceed with communications with the respective STAs during the TXOP in accordance with the synchronization information transmitted via the CSR trigger frame. If the shared AP does not have inner clients (such as the shared AP has outer clients), at 1360, the sharing AP may proceed with communications in accordance with the CSR mode, but the shared AP may not participate. As a result, the sharing AP is using a dedicated (such as unshared) TXOP for communications with the one or more first STAs. If, at 1340, the sharing AP determines that the one or more first STAs are outer clients, the sharing AP may proceed with communicating with the one or more first STAs in accordance with a dedicated TXOP mode (such as no sharing) at 1370.

If at 1305, the sharing AP determines that the sharing AP does not have enough spatial dimensions available for the CBF transmission mode, at 1365, the sharing AP may proceed with CSR mode operations and evaluate whether the one or more clients associated with the sharing AP are inner. If the sharing AP has no inner client, at 1370, the sharing AP may proceed with communicating with the associated STAs via the no TXOP sharing mode. If at 1365, the sharing AP determines that the one or more clients are inner clients, at 1375, the sharing AP may transmit a CSR trigger frame. At 1380, in response to the CSR trigger, the shared AP may evaluate whether the one or more second STAs (associated with the shared AP) are classified as inner clients (such as whether the one or more second STAs are subject to interference by communications by the first AP). If the shared AP has inner clients, at 1385, the sharing and shared APs may proceed with communications with the respective STAs during the TXOP in accordance with the synchronization information transmitted via the CSR trigger frame. If the shared AP does not have inner clients (such as the shared AP has outer clients), at 1370, the sharing AP may proceed with communications in accordance with the CSR mode, but the shared AP may not participate. As a result, the sharing AP is using a dedicated (such as unshared) TXOP for communications with the one or more first STAs. The various signaling that result in operations at 1370 and 1385 may be similar to the signaling described in signaling diagrams of FIGS. 11A-12.

As described herein, the various modes may result in transmission of a block acknowledgment message (such as a BA frame). In symmetric CBF, asymmetric CBF, and CSR transmission modes, it may be beneficial for the APs to successfully receive the block acknowledgment messages. However, in the CSR modes, the issues with BA transmission interference may not be present due to potential isolation between the STAs and respective APs.

Techniques described herein support limiting inter-BSS BA interference in CBF modes and the CSR mode. In accordance with a first operation, the sharing AP, the shared AP, or both may follow a delayed BA policy. For example, in the shared AP operation, no immediate BA response is sent after the DL PPDU. Rather, the shared AP may poll the BA frame later using a block acknowledgment request (BAR) frame (such as BAR frame or implicit BAR) that solicits the BA response. The BAR may be indicated at least an offset duration (such as quantity of resource units) after the DL PPDU frame. A similar technique may be used by the sharing AP rather than the shared AP. In accordance with a second option, the BA messages may be frequency multiplexed. In such scenarios, each AP's PPDU may trigger the BA response from the respective STA(s) at a different set of resource units. This technique may be supported by specifying the resource unit allocation to the STA(s) in the trigger portion of the DL PPDU. The resource unit allocation in each BSS may be either dictated (such as signaled) by the sharing AP in the initial CBF/CSR trigger frame (or ACK/Sync frame) or agreed earlier at the AP coordination relationship establishment phase occurring at the management level of the APs. In some implementations, the bandwidth may be split between the participating APs, and the APs may independently determine the RUs for the STA(s) within their portion of the bandwidth.

Moreover, various frame formats may be used in the CBF-CSR operation framework. For example, the initial coordinated trigger request frame (CBF trigger frame) may be a unified BSRP frame with a field (such as a user information field) that is used to indicate that the frame is a CBF trigger frame. The field may be a AID12 value with a type indicator. The response to the initial trigger frame (such as the CBF response frame) may be a multi-STA BA (MBA, or “multi-STA BlockAck”) frame with an AID/TID combination that indicates that the frame is the CBF response frame. The next response frame (such as transmitted by the sharing AP), which may be an ACK/sync frame, may be a unified BSRP frame with one or more fields that indicate that the information included in the frame. Additionally, or alternatively, the ACK/sync frame may be a BSRP frame with zero length. In some implementations, the ACK/sync frame is an MBA frame.

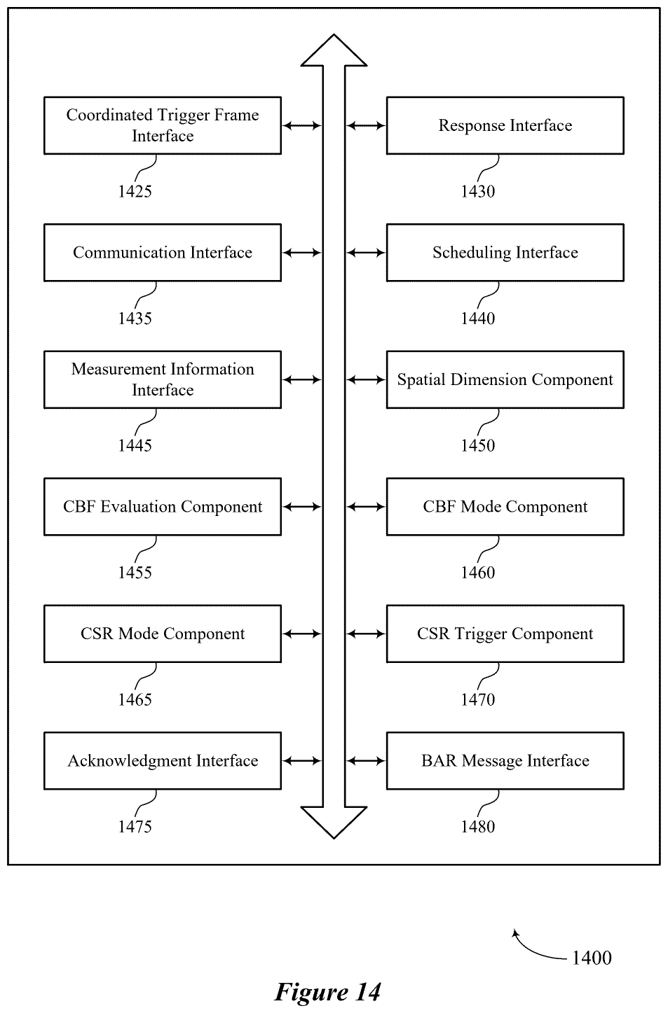

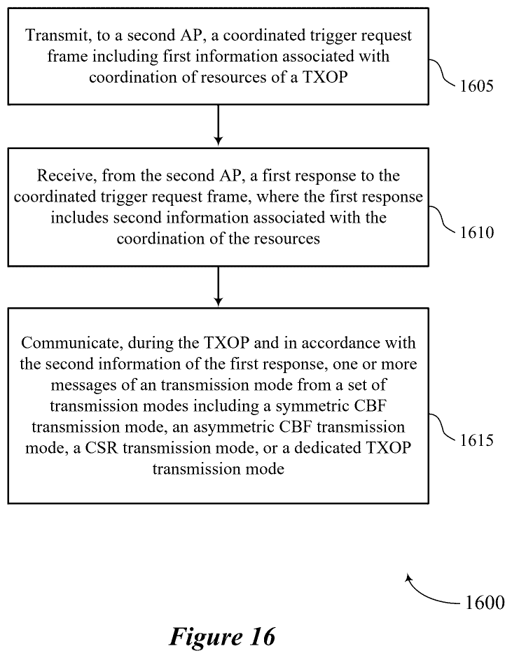

FIG. 14 shows a block diagram of an example wireless communication device 1400 that supports using a unified framework for coordinated transmission modes. In some implementations, the wireless communication device 1400 is configured to perform the processes 1600, 1700, and 1900 described with reference to FIGS. 16, 17, and 19, respectively. The wireless communication device 1400 may include one or more chips, SoCs, chipsets, packages, components or devices that individually or collectively constitute or include a processing system. The processing system may interface with other components of the wireless communication device 1400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1400 may transmit the information output from the chip. In such an example, the second interface may refer to an interface between the processing system of the chip and a reception component, such that the wireless communication device 1400 may receive information that is passed to the processing system. In some such examples, the first interface also may obtain information, such as from the transmission component, and the second interface also may output information, such as to the reception component.

The processing system of the wireless communication device 1400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 1400 can be configurable or configured for use in an AP, such as the AP 102 described with reference to FIG. 1. In some other examples, the wireless communication device 1400 can be an AP that includes such a processing system and other components including multiple antennas. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some implementations, the wireless communication device 1400 also includes or can be coupled with one or more application processors which may be further coupled with one or more other memories. In some implementations, the wireless communication device 1400 further includes at least one external network interface coupled with the processing system that enables communication with a core network or backhaul network that enables the wireless communication device 1400 to gain access to external networks including the Internet.

The wireless communication device 1400 includes a coordinated trigger frame interface 1425, a response interface 1430, a communication interface 1435, a scheduling interface 1440, a measurement information interface 1445, a spatial dimension component 1450, a CBF evaluation component 1455, a CBF mode component 1460, an CSR mode component 1465, an CSR trigger component 1470, an acknowledgment interface 1475, and a BAR message interface 1480. Portions of one or more of the coordinated trigger frame interface 1425, the response interface 1430, the communication interface 1435, the scheduling interface 1440, the measurement information interface 1445, the spatial dimension component 1450, the CBF evaluation component 1455, the CBF mode component 1460, the CSR mode component 1465, the CSR trigger component 1470, the acknowledgment interface 1475, and the BAR message interface 1480 may be implemented at least in part in hardware or firmware. For example, one or more of the coordinated trigger frame interface 1425, the response interface 1430, the communication interface 1435, the scheduling interface 1440, the measurement information interface 1445, the spatial dimension component 1450, the CBF evaluation component 1455, the CBF mode component 1460, the CSR mode component 1465, the CSR trigger component 1470, the acknowledgment interface 1475, and the BAR message interface 1480 may be implemented at least in part by at least a processor or a modem. In some implementations, portions of one or more of the coordinated trigger frame interface 1425, the response interface 1430, the communication interface 1435, the scheduling interface 1440, the measurement information interface 1445, the spatial dimension component 1450, the CBF evaluation component 1455, the CBF mode component 1460, the CSR mode component 1465, the CSR trigger component 1470, the acknowledgment interface 1475, and the BAR message interface 1480 may be implemented at least in part by a processor and software in the form of processor-executable code stored in memory.

The wireless communication device 1400 may support wireless communications in accordance with examples as disclosed herein. The coordinated trigger frame interface 1425 is configurable or configured to transmit, to a second AP, a coordinated trigger request frame including first information associated with coordination of resources of a TXOP. In some examples, the first information includes one or more first identifiers associated with scheduling communications between one or more first STAs and the first AP during the TXOP. The response interface 1430 is configurable or configured to receive, from the second AP, a first response to the coordinated trigger request frame, where the first response includes second information associated with the coordination of the resources. In some examples, the second information is indicative of whether the second AP can attenuate a first transmit signal at the one or more first STAs during the TXOP. The communication interface 1435 is configurable or configured to communicate, during the TXOP and in accordance with the second information of the first response, one or more messages of a transmission mode from a set of transmission modes including a symmetric CBF transmission mode, an asymmetric CBF transmission mode, a CSR transmission mode, or a dedicated TXOP transmission mode (such as a transmission mode from a set of transmission modes including a coordinated transmission mode and a dedicated TXOP transmission mode, where the coordinated transmission mode may be a symmetric CBF transmission mode, an asymmetric CBF transmission mode, or a CSR transmission mode; in other words, the coordinated transmission mode may be a CBF transmission mode or a CSR transmission mode).

In some implementations, the measurement information interface 1445 is configurable or configured to receive, from the one or more first STAs during a measurement phase performed between the first AP and the second AP prior to transmission of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

In some implementations, the measurement information interface 1445 is configurable or configured to receive, from one or more second STAs associated with the second AP and during a measurement phase performed between the first AP and the second AP prior to transmission of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

In some implementations, transmitting a CBF trigger frame as the coordinated trigger request frame in accordance with the first AP having a threshold quantity of spatial dimensions to support a CBF transmission mode during the TXOP.

In some implementations, the CBF evaluation component 1455 is configurable or configured to evaluate whether the first AP can attenuate second transmit signal at one or more second STAs associated with the second AP during the TXOP, where the second information of the first response includes one or more second identifiers associated with scheduling communications between the one or more second STAs and the second AP and where the first AP communicates the one or more messages of the transmission mode from the set of transmission modes in accordance with whether the first AP can an attenuate the second transmit signal.

In some implementations, the first information includes an indication of a first NSS for each STA of the one or more first STAs. In some implementations, the second information includes an indication of a second NSS for each STA of the one or more second STAs.

In some implementations, to support communicating the one or more messages of the transmission mode, the CBF evaluation component 1455 is configurable or configured to transmit, to the second AP, a second response to the first response, where the second response includes third information that indicates that the first AP can attenuate a second transmit signal associated with communications between the second AP and one or more second STAs during the TXOP, where the second information of the first response includes one or more second identifiers associated with scheduling communications between the one or more second STAs and the second AP. In some implementations, to support communicating the one or more messages of the transmission mode, the CBF mode component 1460 is configurable or configured to transmit to the one or more first STAs, during the TXOP in accordance with the symmetric CBF transmission mode, one or more downlink messages, where the symmetric CBF transmission mode is used in accordance with the second AP being capable of attenuating the first transmit signal and the first AP being capable of attenuating the second transmit signal.

In some implementations, the third information includes synchronization information associated with the communications during the TXOP in accordance with the symmetric CBF transmission mode.

In some implementations, to support communicating the one or more messages of the transmission mode, the CBF mode component 1460 is configurable or configured to transmit to the one or more first STAs during the TXOP in accordance with the asymmetric CBF transmission mode, one or more downlink messages, where the asymmetric CBF transmission mode is used in accordance with the second AP being capable of attenuating the first transmit signal and the first AP being incapable of attenuating a second transmit signal associated with communications between the second AP and one or more second STAs during the TXOP.

In some implementations, the CBF evaluation component 1455 is configurable or configured to transmit, to the second AP, a second response to the first response, where the second response includes third information that indicates that the first AP cannot attenuate the second transmit signal associated with communications between the second AP and the one or more second STAs during the TXOP, where the second information of the first response includes one or more second identifiers associated with scheduling communications between the one or more second STAs and the second AP and the third information includes synchronization information associated with the communications during the TXOP in accordance with the asymmetric CBF transmission mode.

In some implementations, to support communicating the one or more messages of the transmission mode, the CBF evaluation component 1455 is configurable or configured to transmit, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP. In some implementations, to support communicating the one or more messages of the transmission mode, the CSR mode component 1465 is configurable or configured to transmit, to the one or more first STAs during the TXOP in accordance with the CSR transmission mode, one or more downlink messages.

In some implementations, to support communicating the one or more messages of the transmission mode, the CSR trigger component 1470 is configurable or configured to transmit, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP. In some implementations, to support communicating the one or more messages of the transmission mode, the communication interface 1435 is configurable or configured to transmit, to the one or more first STAs in accordance with the one or more first STAs being schedulable via the TXOP used by the second AP and the second AP being incapable of attenuating the first transmit signal, one or more downlink messages during the TXOP via the dedicated TXOP transmission mode.

In some implementations, to support communicating the one or more messages of the transmission mode, the communication interface 1435 is configurable or configured to transmit, in accordance with the one or more first STAs being subject to at least a threshold level of interference during communications via the TXOP when used by the second AP and the second AP being incapable of attenuating the first transmit signal, one or more downlink messages to the one or more first STAs during the TXOP in accordance with the dedicated TXOP transmission mode.

In some implementations, to support communicating the one or more messages of the transmission mode, the communication interface 1435 is configurable or configured to transmit, to the one or more first STAs, a data message during a physical layer protocol data unit (PPDU) frame. In some implementations, to support communicating the one or more messages of the transmission mode, the acknowledgment interface 1475 is configurable or configured to receive, from the one or more first STAs and in accordance with the transmission mode, an acknowledgment message associated with the data message.

In some implementations, the acknowledgment message is received within a resource unit that is positioned at an offset relative to the PPDU frame used to transmit the data message.

In some implementations, the BAR message interface 1480 is configurable or configured to transmit, to the one or more first STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

In some implementations, the acknowledgment message is received via a first set of resource units that are different from a second set of resource units used for the acknowledgment message sent by one or more second STAs to the second AP.

In some implementations, the first set of resource units are indicated in the PPDU frame, the coordinated trigger request frame, or the first response.

In some implementations, the first set of resource units is assigned in accordance with one or more communications exchanged with the second AP.

In some implementations, the acknowledgment message includes a block acknowledgment frame.

In some implementations, to support transmitting the coordinated trigger request frame, the coordinated trigger frame interface 1425 is configurable or configured to transmit the coordinated trigger request frame via a BSRP frame, where the BSRP frame includes an indication that the BSRP frame includes the coordinated trigger request frame. In some examples, a user information field of the BSRP frame indicates that the BSRP frame is the coordinated trigger request frame.

In some implementations, to support receiving the first response, the response interface 1430 is configurable or configured to receive a multi-STA block acknowledgment (MBA, or “Multi-STA BlockAck”) frame including an indication that the MBA frame includes a CBF response frame message.

In some implementations, the coordinated trigger request frame indicates an intent to share the TXOP with the second AP and to operate in accordance with the coordinated transmission mode within the TXOP.

In some implementations, the CBF evaluation component 1455 is configurable or configured to transmit, a second response to the first response via a BSRP frame or a multi-STA block acknowledgment frame, where the second response includes third information that indicates whether the first AP can attenuate a second transmit signal associated with communications between the second AP and one or more second STAs during the TXOP.

Additionally, or alternatively, the wireless communication device 1400 may support wireless communications in accordance with examples as disclosed herein. In some implementations, the coordinated trigger frame interface 1425 is configurable or configured to receive, from a second AP, a coordinated trigger request frame including first information associated with coordination of resources of a TXOP. In some examples, the first information includes one or more first identifiers associated with scheduling communications between one or more first STAs and the second AP during the TXOP. In some implementations, the response interface 1430 is configurable or configured to transmit, to the second AP, a first response to the coordinated trigger request frame, the first response including second information associated with the coordination of the resources. In some examples, the second information is indicative of whether the first AP can attenuate a first transmit signal at the one or more first STAs during the TXOP. In some implementations, the communication interface 1435 is configurable or configured to communicate, during the TXOP and in accordance the second information of the first response, one or more messages of a transmission mode from a set of transmission modes including a symmetric CBF transmission mode, an asymmetric CBF transmission mode, a CSR transmission mode, or a dedicated TXOP transmission mode (such as a transmission mode from a set of transmission modes including a coordinated transmission mode and a dedicated TXOP transmission mode, where the coordinated transmission mode may be a symmetric CBF transmission mode, an asymmetric CBF transmission mode, or a CSR transmission mode; in other words, the coordinated transmission mode may be a CBF transmission mode or a CSR transmission mode).

In some implementations, the measurement information interface 1445 is configurable or configured to receive, from one or more second STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

In some implementations, the measurement information interface 1445 is configurable or configured to receive, from the one or more first STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

In some implementations, to support communicating the one or more messages of the transmission mode, the CBF evaluation component 1455 is configurable or configured to receive, from the second AP, a second response to the first response, where the second response includes third information that indicates that the second AP can attenuate a second transmit signal at one or more second STAs during the TXOP, where the second information of the first response includes one or more second identifiers associated with scheduling communications between the one or more second STAs and the first AP. In some implementations, to support communicating the one or more messages of the transmission mode, the CBF mode component 1460 is configurable or configured to transmit, to one or more second STAs during the TXOP in accordance with the symmetric CBF transmission mode, one or more downlink message, where the symmetric CBF transmission mode is used in accordance with the first AP being capable of attenuating the first transmit signal and the second AP being capable of attenuating the second transmit signal.

In some implementations, the third information includes synchronization information associated with communications during the TXOP in accordance with the symmetric CBF transmission mode.

In some implementations, to support communicating the one or more messages of the transmission mode, the CBF mode component 1460 is configurable or configured to transmit, to one or more second STAs during the TXOP in accordance with the asymmetric CBF transmission mode, one or more downlink messages, where the asymmetric CBF transmission mode is used in accordance with the first AP being capable of attenuating the first transmit signal.

In some implementations, the CBF mode component 1460 is configurable or configured to receive, from the second AP, a second response to the first response, where the second response includes third information that indicates that the second AP cannot attenuate a second transmit signal at the one or more second STAs during the TXOP, where the second information of the first response includes one or more second identifiers associated with scheduling communications between the one or more second STAs and the first AP.

In some implementations, to support communicating the one or more messages of the transmission mode, the CSR trigger component 1470 is configurable or configured to receive, from the second AP in accordance with the first response, a CSR trigger frame message including third information associated with coordination of the resources. In some implementations, to support communicating the one or more messages of the transmission mode, the CSR mode component 1465 is configurable or configured to transmit, to one or more second STAs during the TXOP in accordance with the CSR transmission mode, one or more downlink messages.

In some implementations, to support communicating the one or more messages, the communication interface 1435 is configurable or configured to transmit, to one or more second STAs scheduled by the first AP during the TXOP, a data message via a physical layer protocol data unit (PPDU) frame. In some implementations, to support communicating the one or more messages, the acknowledgment interface 1475 is configurable or configured to receive, from the one or more second STAs and in accordance with the transmission mode, an acknowledgment message associated with the data message.

In some implementations, the acknowledgment message is received within a resource unit that is positioned at an offset relative to the PPDU frame used to transmit the data message.

In some implementations, the BAR message interface 1480 is configurable or configured to transmit, to the one or more second STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

In some implementations, the acknowledgment message is received via a first set of resource units of the TXOP that are different from a second set of resource units used for the acknowledgment message sent by the one or more first STAs to the first AP.

In some implementations, the first set of resource units are indicated in the PPDU frame, the coordinated trigger request frame, or the first response.

In some implementations, the first set of resource units is assigned in accordance with one or more communications exchanged with the second AP.

In some implementations, the acknowledgment message includes a block acknowledgment frame.

In some implementations, to support receiving the coordinated trigger request frame, the coordinated trigger frame interface 1425 is configurable or configured to receive the coordinated trigger request frame via a BSRP frame, where BSRP frame includes an indication that the BSRP frame includes the coordinated trigger request frame.

In some implementations, to support transmitting the first response, the coordinated trigger frame interface 1425 is configurable or configured to transmit the first response via a multi-STA block acknowledgment (MBA, or “Multi-STA BlockAck”) frame including an indication that the MBA frame includes the first response that is a CBF response frame message.

In some implementations, the response interface 1430 is configurable or configured to receive a second response to the first response via a BSRP frame or a multi-STA block acknowledgment frame, where the second response includes third information that indicates whether the second AP can attenuate a second null signal to one or more second STAs to be scheduled for communications with the first AP during the TXOP.

Additionally, or alternatively, the wireless communication device 1400 may support wireless communications in accordance with examples as disclosed herein. The scheduling interface 1440 is configurable or configured to transmit a scheduling frame including first information associated with coordination of resources of a TXOP, where the scheduling frame is transmitted in accordance with spatial dimensions supporting a CBF transmission mode during a transmission mode being below a threshold quantity. In some implementations, the communication interface 1435 is configurable or configured to communicate with one or more first STAs during the TXOP in accordance with the scheduling frame.

In some implementations, to support transmitting the scheduling frame, the CSR trigger component 1470 is configurable or configured to transmit, to a second AP, a CSR trigger frame, where the first information includes synchronization information associated with communications with the one or more first STAs during the TXOP.

In some implementations, the CSR trigger frame is transmitted in accordance with the one or more first STAs being subject to less than a threshold level of interference by the second AP during communications via the TXOP.

In some implementations, the scheduling frame is transmitted to the one or more first STAs in accordance with the one or more first STAs being subject to greater than a threshold level of interference by a second AP during communications via the TXOP.

In some implementations, to support communicating the one or more first STAs, the communication interface 1435 is configurable or configured to communicate with the one or more first STAs in accordance with a CSR mode or a dedicated TXOP mode.

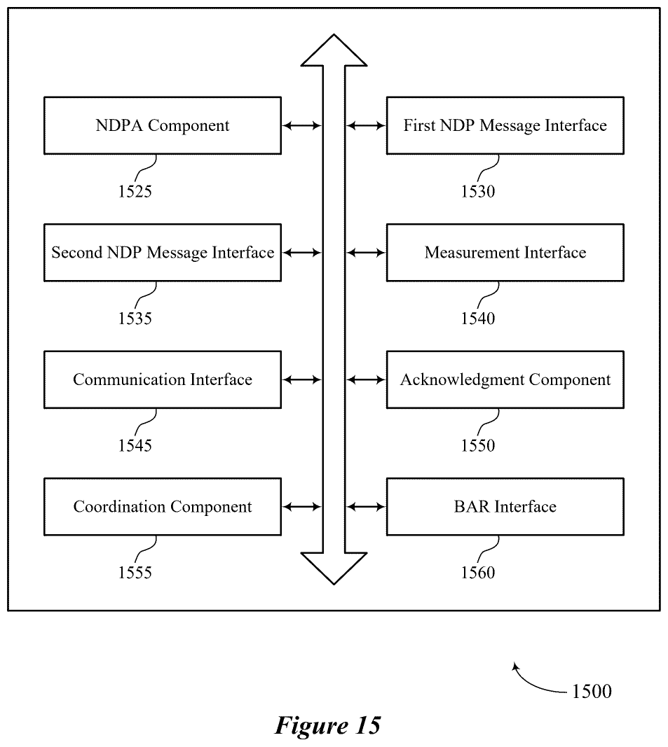

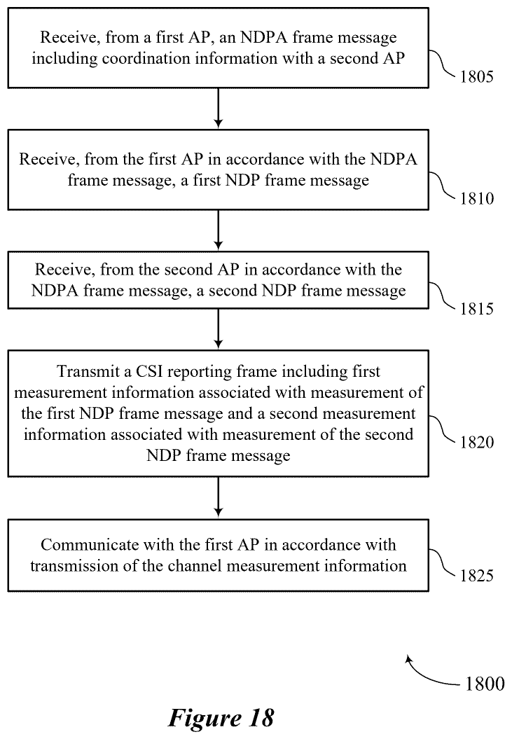

FIG. 15 shows a block diagram of an example wireless communication device 1500 that supports using a unified framework for coordinated transmission modes. In some implementations, the wireless communication device 1500 is configured to perform the process 1800 described with reference to FIG. 18. The wireless communication device 1500 may include one or more chips, SoCs, chipsets, packages, components or devices that individually or collectively constitute or include a processing system. The processing system may interface with other components of the wireless communication device 1500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1500 may transmit the information output from the chip. In such an example, the second interface may refer to an interface between the processing system of the chip and a reception component, such that the wireless communication device 1500 may receive information that is passed to the processing system. In some such examples, the first interface also may obtain information, such as from the transmission component, and the second interface also may output information, such as to the reception component.

The processing system of the wireless communication device 1500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 1500 can be configurable or configured for use in a STA, such as the STA 104 described with reference to FIG. 1. In some other examples, the wireless communication device 1500 can be a STA that includes such a processing system and other components including multiple antennas. The wireless communication device 1500 is capable of transmitting and receiving wireless communications in the form of, for example, wireless packets. For example, the wireless communication device 1500 can be configurable or configured to transmit and receive packets in the form of physical layer PPDUs and MPDUs conforming to one or more of the IEEE 802.11 family of wireless communication protocol standards. In some other examples, the wireless communication device 1500 can be configurable or configured to transmit and receive signals and communications conforming to one or more 3GPP specifications including those for 5G NR or 6G. In some implementations, the wireless communication device 1500 also includes or can be coupled with one or more application processors which may be further coupled with one or more other memories. In some implementations, the wireless communication device 1500 further includes a user interface (UI) (such as a touchscreen or keypad) and a display, which may be integrated with the UI to form a touchscreen display that is coupled with the processing system. In some implementations, the wireless communication device 1500 may further include one or more sensors such as, for example, one or more inertial sensors, accelerometers, temperature sensors, pressure sensors, or altitude sensors, that are coupled with the processing system.

The wireless communication device 1500 includes an NDPA component 1525, a first NDP message interface 1530, a second NDP message interface 1535, a measurement interface 1540, a communication interface 1545, an acknowledgment component 1550, a coordination component 1555, and a BAR interface 1560. Portions of one or more of the NDPA component 1525, the first NDP message interface 1530, the second NDP message interface 1535, the measurement interface 1540, the communication interface 1545, the acknowledgment component 1550, the coordination component 1555, and the BAR interface 1560 may be implemented at least in part in hardware or firmware. For example, one or more of the NDPA component 1525, the first NDP message interface 1530, the second NDP message interface 1535, the measurement interface 1540, the communication interface 1545, the acknowledgment component 1550, the coordination component 1555, and the BAR interface 1560 may be implemented at least in part by at least a processor or a modem. In some implementations, portions of one or more of the NDPA component 1525, the first NDP message interface 1530, the second NDP message interface 1535, the measurement interface 1540, the communication interface 1545, the acknowledgment component 1550, the coordination component 1555, and the BAR interface 1560 may be implemented at least in part by a processor and software in the form of processor-executable code stored in memory.

The wireless communication device 1500 may support wireless communications in accordance with examples as disclosed herein. The NDPA component 1525 is configurable or configured to receive, from a first AP, an NDPA frame message including coordination information with a second AP. The first NDP message interface 1530 is configurable or configured to receive, from the first AP in accordance with the NDPA frame message, a first NDP frame message. The second NDP message interface 1535 is configurable or configured to receive, from the second AP in accordance with the NDPA frame message, a second NDP frame message. The measurement interface 1540 is configurable or configured to transmit a CSI reporting frame including first measurement information associated with measurement of the first NDP frame message and a second measurement information associated with measurement of the second NDP frame message. The communication interface 1545 is configurable or configured to communicate with the first AP in accordance with transmission of the channel measurement information.

In some implementations, the first measurement information includes first channel state information associated with the first NDP frame message and a first received signal strength indicator associated with the first NDP frame message and the second measurement information includes second channel state information associated with the second NDP frame message and a second received signal strength indicator associated with the second NDP frame message.

In some implementations, to support communicating with the first AP, the communication interface 1545 is configurable or configured to receive, from the first AP, one or more downlink messages during a physical layer protocol data unit (PPDU) frame of a TXOP. In some implementations, to support communicating with the first AP, the acknowledgment component 1550 is configurable or configured to transmit, to the first AP, an acknowledgment message associated with the one or more downlink messages.

In some implementations, the coordination component 1555 is configurable or configured to receive, from the first AP in accordance with the first measurement information and the second measurement information, first information that schedules the first STA for communication during the TXOP, where the one or more downlink messages are received during the PPDU frame of the TXOP in accordance with the first information.

In some implementations, the acknowledgment message is transmitted during a resource that is positioned at an offset relative to the PPDU frame used to receive the one or more downlink messages.

In some implementations, the BAR interface 1560 is configurable or configured to receive, from the first AP within a resource unit that is positioned at an offset relative to the PPDU frame used to receive the one or more downlink messages, a block acknowledgment request frame message, where the acknowledgment message is transmitted in accordance with receiving the block acknowledgment request frame message.

In some implementations, the acknowledgment message is transmitted via a first set of resource units that are different from a second set of resource units used for an acknowledgment message sent by one or more second STAs to the second AP.

In some implementations, the first set of resource units is indicated via the PPDU frame or a coordinated trigger request frame.

In some implementations, the acknowledgment message includes a block acknowledgment frame.

FIG. 16 shows a flowchart illustrating an example process 1600 performable by or at a first AP that supports using a unified framework for coordinated transmission modes. The operations of the process 1600 may be implemented by a first AP or its components as described herein. For example, the process 1600 may be performed by a wireless communication device, such as the wireless communication device 1400 described with reference to FIG. 14, operating as or within a wireless AP. In some implementations, the process 1600 may be performed by a wireless AP, such as one of the APs 102 described with reference to FIG. 1.

In some implementations, in 1605, the first AP may transmit, to a second AP, a coordinated trigger request frame including first information associated with coordination of resources of a TXOP. In some examples, the first information includes one or more first identifiers associated with scheduling communications between one or more first STAs and the first AP during the TXOP. The operations of 1605 may be performed in accordance with examples as disclosed herein. In some implementations, aspects of the operations of 1605 may be performed by a coordinated trigger frame interface 1425 as described with reference to FIG. 14.

In some implementations, in 1610, the first AP may receive, from the second AP, a first response to the coordinated trigger request frame, where the first response includes second information associated with the coordination of the resources. In some examples, the second information is indicative of whether the second AP can attenuate a first transmit signal at the one or more first STAs during the TXOP. The operations of 1610 may be performed in accordance with examples as disclosed herein. In some implementations, aspects of the operations of 1610 may be performed by a response interface 1430 as described with reference to FIG. 14.

In some implementations, in 1615, the first AP may communicate, during the TXOP and in accordance with the second information of the first response, one or more messages of a transmission mode from a set of transmission modes including a symmetric CBF transmission mode, an asymmetric CBF transmission mode, a CSR transmission mode, or a dedicated TXOP transmission mode (such as from a set of transmission modes including a coordinated transmission mode and a dedicated TXOP transmission mode). The operations of 1615 may be performed in accordance with examples as disclosed herein. In some implementations, aspects of the operations of 1615 may be performed by a communication interface 1435 as described with reference to FIG. 14.

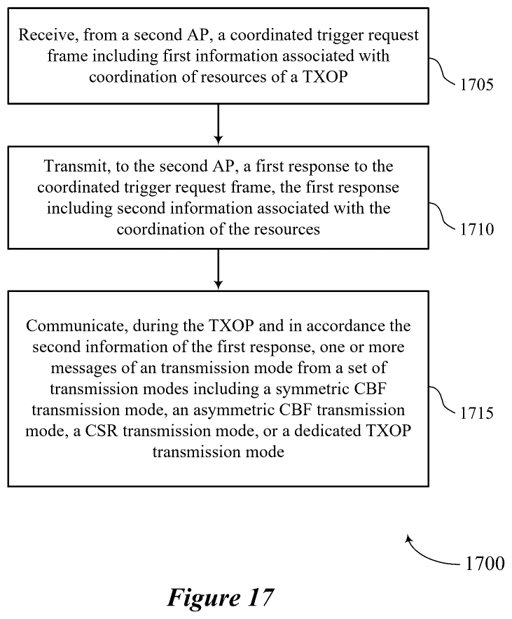

FIG. 17 shows a flowchart illustrating an example process 1700 performable by or at a first AP that supports using a unified framework for coordinated transmission modes. The operations of the process 1700 may be implemented by a first AP or its components as described herein. For example, the process 1700 may be performed by a wireless communication device, such as the wireless communication device 1400 described with reference to FIG. 14, operating as or within a wireless AP. In some implementations, the process 1700 may be performed by a wireless AP, such as one of the APs 102 described with reference to FIG. 1.

In some implementations, in 1705, the first AP may receive, from a second AP, a coordinated trigger request frame including first information associated with coordination of resources of a TXOP. In some examples, the first information includes one or more first identifiers associated with scheduling communications between one or more first STAs and the second AP during the TXOP. The operations of 1705 may be performed in accordance with examples as disclosed herein. In some implementations, aspects of the operations of 1705 may be performed by a coordinated trigger frame interface 1425 as described with reference to FIG. 14.

In some implementations, in 1710, the first AP may transmit, to the second AP, a first response to the coordinated trigger request frame, the first response including second information associated with the coordination of the resources. In some examples, the second information is indicative of whether the first AP can attenuate a first transmit signal at the one or more first STAs during the TXOP. The operations of 1710 may be performed in accordance with examples as disclosed herein. In some implementations, aspects of the operations of 1710 may be performed by a response interface 1430 as described with reference to FIG. 14.

In some implementations, in 1715, the first AP may communicate, during the TXOP and in accordance the second information of the first response, one or more messages of a transmission mode from a set of transmission modes including a symmetric CBF transmission mode, an asymmetric CBF transmission mode, a CSR transmission mode, or a dedicated TXOP transmission mode (such as from a set of transmission modes including a coordinated transmission mode and a dedicated TXOP transmission mode). The operations of 1715 may be performed in accordance with examples as disclosed herein. In some implementations, aspects of the operations of 1715 may be performed by a communication interface 1435 as described with reference to FIG. 14.

FIG. 18 shows a flowchart illustrating an example process 1800 performable by or at a first STA that supports using a unified framework for coordinated transmission modes. The operations of the process 1800 may be implemented by a first STA or its components as described herein. For example, the process 1800 may be performed by a wireless communication device, such as the wireless communication device 1500 described with reference to FIG. 15, operating as or within a wireless STA. In some implementations, the process 1800 may be performed by a wireless STA, such as one of the STAs 104 described with reference to FIG. 1.

In some implementations, in 1805, the first STA may receive, from a first AP, an NDPA frame message including coordination information with a second AP. The operations of 1805 may be performed in accordance with examples as disclosed herein. In some implementations, aspects of the operations of 1805 may be performed by an NDPA component 1525 as described with reference to FIG. 15.

In some implementations, in 1810, the first STA may receive, from the first AP in accordance with the NDPA frame message, a first NDP frame message. The operations of 1810 may be performed in accordance with examples as disclosed herein. In some implementations, aspects of the operations of 1810 may be performed by a first NDP message interface 1530 as described with reference to FIG. 15.

In some implementations, in 1815, the first STA may receive, from the second AP in accordance with the NDPA frame message, a second NDP frame message. The operations of 1815 may be performed in accordance with examples as disclosed herein. In some implementations, aspects of the operations of 1815 may be performed by a second NDP message interface 1535 as described with reference to FIG. 15.

In some implementations, in 1820, the first STA may transmit a CSI reporting frame including first measurement information associated with measurement of the first NDP frame message and a second measurement information associated with measurement of the second NDP frame message. The operations of 1820 may be performed in accordance with examples as disclosed herein. In some implementations, aspects of the operations of 1820 may be performed by a measurement interface 1540 as described with reference to FIG. 15.

In some implementations, in 1825, the first STA may communicate with the first AP in accordance with transmission of the channel measurement information. The operations of 1825 may be performed in accordance with examples as disclosed herein. In some implementations, aspects of the operations of 1825 may be performed by a communication interface 1545 as described with reference to FIG. 15.

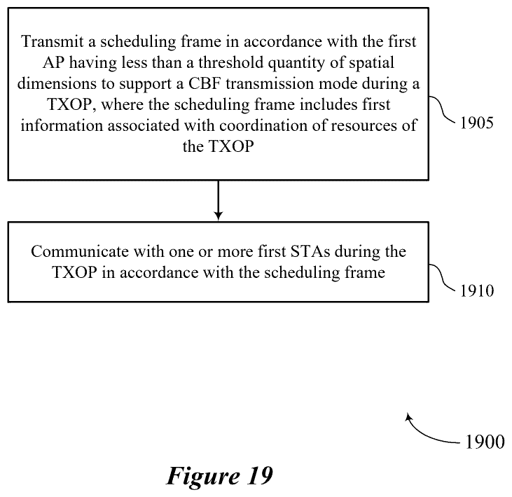

FIG. 19 shows a flowchart illustrating an example process 1900 performable by or at a first AP that supports using a unified framework for coordinated transmission modes. The operations of the process 1900 may be implemented by a first AP or its components as described herein. For example, the process 1900 may be performed by a wireless communication device, such as the wireless communication device 1400 described with reference to FIG. 14, operating as or within a wireless AP. In some implementations, the process 1900 may be performed by a wireless AP, such as one of the APs 102 described with reference to FIG. 1.

In some implementations, in 1905, the first AP may transmit a scheduling frame including first information associated with coordination of resources of a TXOP, where the scheduling frame is transmitted in accordance with spatial dimensions supporting a CBF transmission mode during a transmission mode being below a threshold quantity. The operations of 1905 may be performed in accordance with examples as disclosed herein. In some implementations, aspects of the operations of 1905 may be performed by a scheduling interface 1440 as described with reference to FIG. 14.

In some implementations, in 1910, the first AP may communicate with one or more first STAs during the TXOP in accordance with the scheduling frame. The operations of 1910 may be performed in accordance with examples as disclosed herein. In some implementations, aspects of the operations of 1910 may be performed by a communication interface 1435 as described with reference to FIG. 14.

Implementation examples are described in the following numbered clauses:

Clause 1: A method for wireless communications at a first AP, including: transmitting, to a second AP, a coordinated trigger request frame including first information associated with coordination of resources of a TXOP, where the first information includes one or more first identifiers associated with scheduling communications between one or more first STAs and the first AP during the TXOP; receiving, from the second AP, a first response to the coordinated trigger request frame, where the first response includes second information associated with the coordination of the resources, where the second information is indicative of whether the second AP can attenuate a first transmit signal at the one or more first STAs during the TXOP; and communicating, during the TXOP and in accordance with the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 2: The method of clause 1, further including: receiving, from the one or more first STAs during a measurement phase performed between the first AP and the second AP prior to transmission of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 3: The method of any of clauses 1-2, further including: receiving, from one or more second STAs associated with the second AP and during a measurement phase performed between the first AP and the second AP prior to transmission of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 4: The method of any of clauses 1-3, where transmitting the coordinated trigger request frame transmitting a CBF trigger frame as the coordinated trigger request frame in accordance with the first AP having a threshold quantity of spatial dimensions to support a CBF transmission mode during the TXOP.

Clause 5: The method of any of clauses 1-4, further including: evaluating whether the first AP can attenuate second transmit signal at one or more second STAs associated with the second AP during the TXOP, where the second information of the first response includes one or more second identifiers associated with scheduling communications between the one or more second STAs and the second AP and where the first AP communicates the one or more messages of the transmission mode from the set of transmission modes in accordance with whether the first AP can an attenuate the second transmit signal.

Clause 6: The method of any of clauses 1-5, where the first response indicates that the second AP can attenuate the first transmit signal and where communicating the one or more messages of the transmission mode includes: transmitting, to the second AP, a second response to the first response, where the second response includes third information that indicates that the first AP can attenuate a second transmit signal associated with communications between the second AP and one or more second STAs during the TXOP, where the second information of the first response includes one or more second identifiers associated with scheduling communications between the one or more second STAs and the second AP; and transmitting to the one or more first STAs, during the TXOP in accordance with the symmetric CBF transmission mode, one or more downlink messages, where the symmetric CBF transmission mode is used in accordance with the second AP being capable of attenuating the first transmit signal and the first AP being capable of attenuating the second transmit signal.

Clause 7: The method of clause 6, where the third information includes synchronization information associated with the communications during the TXOP in accordance with the symmetric CBF transmission mode.

Clause 8: The method of any of clauses 1-5, where the first response indicates that the second AP can attenuate the first transmit signal and where communicating the one or more messages of the transmission mode includes: transmitting to the one or more first STAs during the TXOP in accordance with the asymmetric CBF transmission mode, one or more downlink messages, where the asymmetric CBF transmission mode is used in accordance with the second AP being capable of attenuating the first transmit signal and the first AP being incapable of attenuating a second transmit signal associated with communications between the second AP and one or more second STAs during the TXOP.

Clause 9: The method of clause 8, further including: transmitting, to the second AP, a second response to the first response, where the second response includes third information that indicates that the first AP cannot attenuate the second transmit signal associated with communications between the second AP and the one or more second STAs during the TXOP, where the second information of the first response includes one or more second identifiers associated with scheduling communications between the one or more second STAs and the second AP and the third information includes synchronization information associated with the communications during the TXOP in accordance with the asymmetric CBF transmission mode.

Clause 10: The method of any of clauses 1-5, where the first response indicates the second AP cannot attenuate the first transmit signal and where communicating the one or more messages of the transmission mode includes: transmitting, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and transmitting, to the one or more first STAs during the TXOP in accordance with the CSR transmission mode, one or more downlink messages.

Clause 11: The method of any of clauses 1-5, where the first response indicates the second AP cannot attenuate the first transmit signal and where communicating the one or more messages of the transmission mode includes: transmitting, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and transmitting, to the one or more first STAs in accordance with the one or more first STAs being schedulable via the TXOP used by the second AP and the second AP being incapable of attenuating the first transmit signal, one or more downlink messages during the TXOP via the dedicated TXOP transmission mode.

Clause 12: The method of any of clauses 1-5, where the first response indicates the second AP cannot attenuate the first transmit signal and where communicating the one or more messages of the transmission mode includes: transmitting, in accordance with the one or more first STAs being subject to at least a threshold level of interference during communications via the TXOP when used by the second AP and the second AP being incapable of attenuating the first transmit signal, one or more downlink messages to the one or more first STAs during the TXOP in accordance with the dedicated TXOP transmission mode.

Clause 13: The method of any of clauses 1-12, where communicating the one or more messages of the transmission mode includes: transmitting, to the one or more first STAs, a data message during a PPDU frame; and receiving, from the one or more first STAs and in accordance with the transmission mode, an acknowledgment message associated with the data message.

Clause 14: The method of clause 13, where the acknowledgment message is received within a resource unit that is positioned at an offset relative to the PPDU frame used to transmit the data message.

Clause 15: The method of any of clauses 13-14, further including: transmitting, to the one or more first STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 16: The method of any of clauses 13-15, where the acknowledgment message is received via a first set of resource units that are different from a second set of resource units used for the acknowledgment message sent by one or more second STAs to the second AP.

Clause 17: The method of clause 16, where the first set of resource units are indicated in the PPDU frame, the coordinated trigger request frame, or the first response.

Clause 18: The method of any of clauses 16-17, where the first set of resource units is assigned in accordance with one or more communications exchanged with the second AP.

Clause 19: The method of any of clauses 13-18, where the acknowledgment message includes a block acknowledgment frame.

Clause 20: The method of any of clauses 1-19, where transmitting the coordinated trigger request frame includes: transmitting the coordinated trigger request frame via a BSRP frame, where the BSRP frame includes an indication that the BSRP frame includes the coordinated trigger request frame.

Clause 21: The method of any of clauses 1-20, where receiving the first response includes: receiving an MBA frame including an indication that the MBA frame includes a CBF response frame message.

Clause 22: The method of any of clauses 1-21, further including: transmitting, a second response to the first response via a BSRP frame or a multi-STA block acknowledgment frame, where the second response includes third information that indicates whether the first AP can attenuate a second transmit signal associated with communications between the second AP and one or more second STAs during the TXOP.

Clause 23: A method for wireless communications at a first AP, including: receiving, from a second AP, a coordinated trigger request frame including first information associated with coordination of resources of a TXOP, where the first information includes one or more first identifiers associated with scheduling communications between one or more first STAs and the second AP during the TXOP; transmitting, to the second AP, a first response to the coordinated trigger request frame, the first response including second information associated with the coordination of the resources, where the second information is indicative of whether the first AP can attenuate a first transmit signal at the one or more first STAs during the TXOP; and communicating, during the TXOP and in accordance the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 24: The method of clause 23, further including: receiving, from one or more second STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 25: The method of any of clauses 23-24, further including: receiving, from the one or more first STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 26: The method of any of clauses 23-25, where the first response indicates that the first AP can attenuate the first transmit signal and where communicating the one or more messages of the transmission mode includes: receiving, from the second AP, a second response to the first response, where the second response includes third information that indicates that the second AP can attenuate a second transmit signal at one or more second STAs during the TXOP, where the second information of the first response includes one or more second identifiers associated with scheduling communications between the one or more second STAs and the first AP; and transmitting, to one or more second STAs during the TXOP in accordance with the symmetric CBF transmission mode, one or more downlink message, where the symmetric CBF transmission mode is used in accordance with the first AP being capable of attenuating the first transmit signal and the second AP being capable of attenuating the second transmit signal.

Clause 27: The method of clause 26, where the third information includes synchronization information associated with communications during the TXOP in accordance with the symmetric CBF transmission mode.

Clause 28: The method of any of clauses 23-25, where the first response indicates that the first AP can attenuate the first transmit signal and where communicating the one or more messages of the transmission mode includes: transmitting, to one or more second STAs during the TXOP in accordance with the asymmetric CBF transmission mode, one or more downlink messages, where the asymmetric CBF transmission mode is used in accordance with the first AP being capable of attenuating the first transmit signal.

Clause 29: The method of clause 28, further including: receiving, from the second AP, a second response to the first response, where the second response includes third information that indicates that the second AP cannot attenuate a second transmit signal at the one or more second STAs during the TXOP, where the second information of the first response includes one or more second identifiers associated with scheduling communications between the one or more second STAs and the first AP.

Clause 30: The method of any of clauses 23-25, where the first response indicates the first AP cannot attenuate the first transmit signal and where communicating the one or more messages of the transmission mode includes: receiving, from the second AP in accordance with the first response, a CSR trigger frame message including third information associated with coordination of the resources; and transmitting, to one or more second STAs during the TXOP in accordance with the CSR transmission mode, one or more downlink messages.

Clause 31: The method of any of clauses 23-25, where communicating the one or more messages includes: transmitting, to one or more second STAs scheduled by the first AP during the TXOP, a data message via a PPDU frame; and receiving, from the one or more second STAs and in accordance with the transmission mode, an acknowledgment message associated with the data message.

Clause 32: The method of clause 31, where the acknowledgment message is received within a resource unit that is positioned at an offset relative to the PPDU frame used to transmit the data message.

Clause 33: The method of any of clauses 31-32, further including: transmitting, to the one or more second STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 34: The method of any of clauses 31-33, where the acknowledgment message is received via a first set of resource units of the TXOP that are different from a second set of resource units used for the acknowledgment message sent by the one or more first STAs to the first AP.

Clause 35: The method of clause 34, where the first set of resource units are indicated in the PPDU frame, the coordinated trigger request frame, or the first response.

Clause 36: The method of any of clauses 34-35, where the first set of resource units is assigned in accordance with one or more communications exchanged with the second AP.

Clause 37: The method of any of clauses 31-36, where the acknowledgment message includes a block acknowledgment frame.

Clause 38: The method of any of clauses 23-37, where receiving the coordinated trigger request frame includes: receiving the coordinated trigger request frame via a BSRP frame, where BSRP frame includes an indication that the BSRP frame includes the coordinated trigger request frame.

Clause 39: The method of any of clauses 23-38, where transmitting the first response includes: transmitting the first response via an MBA frame including an indication that the MBA frame includes the first response that is a CBF response frame message.

Clause 40: The method of any of clauses 23-39, further including: receiving a second response to the first response via a BSRP frame or a multi-STA block acknowledgment frame, where the second response includes third information that indicates whether the second AP can attenuate a second null signal to one or more second STAs to be scheduled for communications with the first AP during the TXOP.

Clause 41: A method for wireless communications at a first STA, including: receiving, from a first AP, an NDPA frame message including coordination information with a second AP; receiving, from the first AP in accordance with the NDPA frame message, a first NDP frame message; receiving, from the second AP in accordance with the NDPA frame message, a second NDP frame message; transmitting a CSI reporting frame including first measurement information associated with measurement of the first NDP frame message and a second measurement information associated with measurement of the second NDP frame message; and communicating with the first AP in accordance with transmission of the channel measurement information.

Clause 42: The method of clause 41, where the first measurement information includes first channel state information associated with the first NDP frame message and a first received signal strength indicator associated with the first NDP frame message and the second measurement information includes second channel state information associated with the second NDP frame message and a second received signal strength indicator associated with the second NDP frame message.

Clause 43: The method of any of clauses 41-42, where communicating with the first AP includes: receiving, from the first AP, one or more downlink messages during a PPDU frame of a TXOP; and transmitting, to the first AP, an acknowledgment message associated with the one or more downlink messages.

Clause 44: The method of clause 43, further including: receiving, from the first AP in accordance with the first measurement information and the second measurement information, first information that schedules the first STA for communication during the TXOP, where the one or more downlink messages are received during the PPDU frame of the TXOP in accordance with the first information.

Clause 45: The method of any of clauses 43-44, where the acknowledgment message is transmitted during a resource that is positioned at an offset relative to the PPDU frame used to receive the one or more downlink messages.

Clause 46: The method of any of clauses 43-45, further including: receiving, from the first AP within a resource unit that is positioned at an offset relative to the PPDU frame used to receive the one or more downlink messages, a block acknowledgment request frame message, where the acknowledgment message is transmitted in accordance with receiving the block acknowledgment request frame message.

Clause 47: The method of any of clauses 43-46, where the acknowledgment message is transmitted via a first set of resource units that are different from a second set of resource units used for an acknowledgment message sent by one or more second STAs to the second AP.

Clause 48: The method of clause 47, where the first set of resource units is indicated via the PPDU frame or a coordinated trigger request frame.

Clause 49: The method of any of clauses 43-48, where the acknowledgment message includes a block acknowledgment frame.

Clause 50: A method for wireless communications at a first AP, including: transmitting a scheduling frame including first information associated with coordination of resources of a TXOP, where the scheduling frame is transmitted in accordance with spatial dimensions supporting a CBF transmission mode during a transmission mode being below a threshold quantity; and communicating with one or more first STAs during the TXOP in accordance with the scheduling frame.

Clause 51: The method of clause 50, where transmitting the scheduling frame includes: transmitting, to a second AP, a CSR trigger frame, where the first information includes synchronization information associated with communications with the one or more first STAs during the TXOP.

Clause 52: The method of clause 51, where the CSR trigger frame is transmitted in accordance with the one or more first STAs being subject to less than a threshold level of interference by the second AP during communications via the TXOP.

Clause 53: The method of any of clauses 50-52, where the scheduling frame is transmitted to the one or more first STAs in accordance with the one or more first STAs being subject to greater than a threshold level of interference by a second AP during communications via the TXOP.

Clause 54: The method of any of clauses 50-53, where communicating the one or more first STAs includes: communicating with the one or more first STAs in accordance with a CSR mode or a dedicated TXOP mode.

Clause 55: A first AP, including: a processing system that includes processor circuitry and memory circuitry that stores code, the processing system configured to cause the first AP to: transmit, to a second AP, a coordinated trigger request frame including first information associated with coordination of resources of a TXOP, where the first information includes one or more first identifiers associated with scheduling communications between one or more first STAs and the first AP during the TXOP; receive, from the second AP, a first response to the coordinated trigger request frame, where the first response includes second information associated with the coordination of the resources, where the second information is indicative of whether the second AP can attenuate a first transmit signal at the one or more first STAs during the TXOP; and communicate, during the TXOP and in accordance with the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 56: The first AP of clause 55, where the processing system is further configured to cause the first AP to: receive, from the one or more first STAs during a measurement phase performed between the first AP and the second AP prior to transmission of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 57: The first AP of any of clauses 55-56, where the processing system is further configured to cause the first AP to: receive, from one or more second STAs associated with the second AP and during a measurement phase performed between the first AP and the second AP prior to transmission of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 58: The first AP of any of clauses 55-57, where transmitting a CBF trigger frame as the coordinated trigger request frame in accordance with the first AP having a threshold quantity of spatial dimensions to support a CBF transmission mode during the TXOP.

Clause 59: The first AP of any of clauses 55-58, where the processing system is further configured to cause the first AP to: evaluate whether the first AP can attenuate second transmit signal at one or more second STAs associated with the second AP during the TXOP, where the second information of the first response includes one or more second identifiers associated with scheduling communications between the one or more second STAs and the second AP and where the first AP communicates the one or more messages of the transmission mode from the set of transmission modes in accordance with whether the first AP can an attenuate the second transmit signal.

Clause 60: The first AP of any of clauses 55-59, where, to communicate the one or more messages of the transmission mode, the processing system is configured to cause the first AP to: transmit, to the second AP, a second response to the first response, where the second response includes third information that indicates that the first AP can attenuate a second transmit signal associated with communications between the second AP and one or more second STAs during the TXOP, where the second information of the first response includes one or more second identifiers associated with scheduling communications between the one or more second STAs and the second AP; and transmit to the one or more first STAs, during the TXOP in accordance with the symmetric CBF transmission mode, one or more downlink messages, where the symmetric CBF transmission mode is used in accordance with the second AP being capable of attenuating the first transmit signal and the first AP being capable of attenuating the second transmit signal.

Clause 61: The first AP of clause 60, where the third information includes synchronization information associated with the communications during the TXOP in accordance with the symmetric CBF transmission mode.

Clause 62: The first AP of any of clauses 55-59, where, to communicate the one or more messages of the transmission mode, the processing system is configured to cause the first AP to: transmit to the one or more first STAs during the TXOP in accordance with the asymmetric CBF transmission mode, one or more downlink messages, where the asymmetric CBF transmission mode is used in accordance with the second AP being capable of attenuating the first transmit signal and the first AP being incapable of attenuating a second transmit signal associated with communications between the second AP and one or more second STAs during the TXOP.

Clause 63: The first AP of clause 62, where the processing system is further configured to cause the first AP to: transmit, to the second AP, a second response to the first response, where the second response includes third information that indicates that the first AP cannot attenuate the second transmit signal associated with communications between the second AP and the one or more second STAs during the TXOP, where the second information of the first response includes one or more second identifiers associated with scheduling communications between the one or more second STAs and the second AP and the third information includes synchronization information associated with the communications during the TXOP in accordance with the asymmetric CBF transmission mode.

Clause 64: The first AP of any of clauses 55-59, where, to communicate the one or more messages of the transmission mode, the processing system is configured to cause the first AP to: transmit, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and transmit, to the one or more first STAs during the TXOP in accordance with the CSR transmission mode, one or more downlink messages.

Clause 65: The first AP of any of clauses 55-59, where, to communicate the one or more messages of the transmission mode, the processing system is configured to cause the first AP to: transmit, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and transmit, to the one or more first STAs in accordance with the one or more first STAs being schedulable via the TXOP used by the second AP and the second AP being incapable of attenuating the first transmit signal, one or more downlink messages during the TXOP via the dedicated TXOP transmission mode.

Clause 66: The first AP of any of clauses 55-65, where, to communicate the one or more messages of the transmission mode, the processing system is configured to cause the first AP to: transmit, in accordance with the one or more first STAs being subject to at least a threshold level of interference during communications via the TXOP when used by the second AP and the second AP being incapable of attenuating the first transmit signal, one or more downlink messages to the one or more first STAs during the TXOP in accordance with the dedicated TXOP transmission mode.

Clause 67: The first AP of any of clauses 55-66, where, to communicate the one or more messages of the transmission mode, the processing system is configured to cause the first AP to: transmit, to the one or more first STAs, a data message during a PPDU frame; and receive, from the one or more first STAs and in accordance with the transmission mode, an acknowledgment message associated with the data message.

Clause 68: The first AP of clause 67, where the acknowledgment message is received within a resource unit that is positioned at an offset relative to the PPDU frame used to transmit the data message.

Clause 69: The first AP of any of clauses 67-68, where the processing system is further configured to cause the first AP to: transmit, to the one or more first STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 70: The first AP of any of clauses 67-69, where the acknowledgment message is received via a first set of resource units that are different from a second set of resource units used for the acknowledgment message sent by one or more second STAs to the second AP.

Clause 71: The first AP of clause 70, where the first set of resource units are indicated in the PPDU frame, the coordinated trigger request frame, or the first response.

Clause 72: The first AP of any of clauses 70-71, where the first set of resource units is assigned in accordance with one or more communications exchanged with the second AP.

Clause 73: The first AP of any of clauses 67-72, where the acknowledgment message includes a block acknowledgment frame.

Clause 74: The first AP of any of clauses 55-73, where, to transmit the coordinated trigger request frame, the processing system is configured to cause the first AP to: transmit the coordinated trigger request frame via a BSRP frame, where the BSRP frame includes an indication that the BSRP frame includes the coordinated trigger request frame.

Clause 75: The first AP of any of clauses 55-74, where, to receive the first response, the processing system is configured to cause the first AP to: receive an MBA frame including an indication that the MBA frame includes a CBF response frame message.

Clause 76: The first AP of any of clauses 55-75, where the processing system is further configured to cause the first AP to: transmit, a second response to the first response via a BSRP frame or a multi-STA block acknowledgment frame, where the second response includes third information that indicates whether the first AP can attenuate a second transmit signal associated with communications between the second AP and one or more second STAs during the TXOP.

Clause 77: A first AP, including: a processing system that includes processor circuitry and memory circuitry that stores code, the processing system configured to cause the first AP to: receive, from a second AP, a coordinated trigger request frame including first information associated with coordination of resources of a TXOP, where the first information includes one or more first identifiers associated with scheduling communications between one or more first STAs and the second AP during the TXOP; transmit, to the first AP, a first response to the coordinated trigger request frame, the first response including second information associated with the coordination of the resources, where the second information is indicative of whether the first AP can attenuate a first transmit signal at the one or more first STAs during the TXOP; and communicate, during the TXOP and in accordance the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 78: The first AP of clause 77, where the processing system is further configured to cause the first AP to: receive, from one or more second STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 79: The first AP of any of clauses 77-78, where the processing system is further configured to cause the first AP to: receive, from the one or more first STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 80: The first AP of any of clauses 77-79, where, to communicate the one or more messages of the transmission mode, the processing system is configured to cause the first AP to: receive, from the second AP, a second response to the first response, where the second response includes third information that indicates that the second AP can attenuate a second transmit signal at one or more second STAs during the TXOP, where the second information of the first response includes one or more second identifiers associated with scheduling communications between the one or more second STAs and the first AP; and transmit, to one or more second STAs during the TXOP in accordance with the symmetric CBF transmission mode, one or more downlink message, where the symmetric CBF transmission mode is used in accordance with the first AP being capable of attenuating the first transmit signal and the second AP being capable of attenuating the second transmit signal.

Clause 81: The first AP of clause 80, where the third information includes synchronization information associated with communications during the TXOP in accordance with the symmetric CBF transmission mode.

Clause 82: The first AP of any of clauses 77-79, where, to communicate the one or more messages of the transmission mode, the processing system is configured to cause the first AP to: transmit, to one or more second STAs during the TXOP in accordance with the asymmetric CBF transmission mode, one or more downlink messages, where the asymmetric CBF transmission mode is used in accordance with the first AP being capable of attenuating the first transmit signal.

Clause 83: The first AP of clause 82, where the processing system is further configured to cause the first AP to: receive, from the second AP, a second response to the first response, where the second response includes third information that indicates that the second AP cannot attenuate a second transmit signal at the one or more second STAs during the TXOP, where the second information of the first response includes one or more second identifiers associated with scheduling communications between the one or more second STAs and the first AP.

Clause 84: The first AP of any of clauses 77-79, where, to communicate the one or more messages of the transmission mode, the processing system is configured to cause the first AP to: receive, from the second AP in accordance with the first response, a CSR trigger frame message including third information associated with coordination of the resources; and transmit, to one or more second STAs during the TXOP in accordance with the CSR transmission mode, one or more downlink messages.

Clause 85: The first AP of any of clauses 77-79, where, to communicate the one or more messages, the processing system is configured to cause the first AP to: transmit, to one or more second STAs scheduled by the first AP during the TXOP, a data message via a PPDU frame; and receive, from the one or more second STAs and in accordance with the transmission mode, an acknowledgment message associated with the data message.

Clause 86: The first AP of clause 85, where the acknowledgment message is received within a resource unit that is positioned at an offset relative to the PPDU frame used to transmit the data message.

Clause 87: The first AP of any of clauses 85-86, where the processing system is further configured to cause the first AP to: transmit, to the one or more second STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 88: The first AP of any of clauses 85-87, where the acknowledgment message is received via a first set of resource units of the TXOP that are different from a second set of resource units used for the acknowledgment message sent by the one or more first STAs to the first AP.

Clause 89: The first AP of clause 88, where the first set of resource units are indicated in the PPDU frame, the coordinated trigger request frame, or the first response.

Clause 90: The first AP of any of clauses 88-89, where the first set of resource units is assigned in accordance with one or more communications exchanged with the second AP.

Clause 91: The first AP of any of clauses 85-90, where the acknowledgment message includes a block acknowledgment frame.

Clause 92: The first AP of any of clauses 77-91, where, to receive the coordinated trigger request frame, the processing system is configured to cause the first AP to: receive the coordinated trigger request frame via a BSRP frame, where BSRP frame includes an indication that the BSRP frame includes the coordinated trigger request frame.

Clause 93: The first AP of any of clauses 77-92, where, to transmit the first response, the processing system is configured to cause the first AP to: transmit the first response via an MBA frame including an indication that the MBA frame includes the first response that is a CBF response frame message.

Clause 94: The first AP of any of clauses 77-93, where the processing system is further configured to cause the first AP to: receive a second response to the first response via a BSRP frame or a multi-STA block acknowledgment frame, where the second response includes third information that indicates whether the second AP can attenuate a second null signal to one or more second STAs to be scheduled for communications with the first AP during the TXOP.

Clause 95: A first STA, including: a processing system that includes processor circuitry and memory circuitry that stores code, the processing system configured to cause the first STA to: receive, from a first AP, an NDPA frame message including coordination information with a second AP; receive, from the first AP in accordance with the NDPA frame message, a first NDP frame message; receive, from the second AP in accordance with the NDPA frame message, a second NDP frame message; transmit a CSI reporting frame including first measurement information associated with measurement of the first NDP frame message and a second measurement information associated with measurement of the second NDP frame message; and communicate with the first AP in accordance with transmission of the channel measurement information.

Clause 96: The first STA of clause 95, where the first measurement information includes first channel state information associated with the first NDP frame message and a first received signal strength indicator associated with the first NDP frame message and the second measurement information includes second channel state information associated with the second NDP frame message and a second received signal strength indicator associated with the second NDP frame message.

Clause 97: The first STA of any of clauses 95-96, where, to communicate with the first AP, the processing system is configured to cause the first STA to: receive, from the first AP, one or more downlink messages during a PPDU frame of a TXOP; and transmit, to the first AP, an acknowledgment message associated with the one or more downlink messages.

Clause 98: The first STA of clause 97, where the processing system is further configured to cause the first STA to: receive, from the first AP in accordance with the first measurement information and the second measurement information, first information that schedules the first STA for communication during the TXOP, where the one or more downlink messages are received during the PPDU frame of the TXOP in accordance with the first information.

Clause 99: The first STA of any of clauses 97-98, where the acknowledgment message is transmitted during a resource that is positioned at an offset relative to the PPDU frame used to receive the one or more downlink messages.

Clause 100: The first STA of any of clauses 97-99, where the processing system is further configured to cause the first STA to: receive, from the first AP within a resource unit that is positioned at an offset relative to the PPDU frame used to receive the one or more downlink messages, a block acknowledgment request frame message, where the acknowledgment message is transmitted in accordance with receiving the block acknowledgment request frame message.

Clause 101: The first STA of any of clauses 97-100, where the acknowledgment message is transmitted via a first set of resource units that are different from a second set of resource units used for an acknowledgment message sent by one or more second STAs to the second AP.

Clause 102: The first STA of clause 101, where the first set of resource units is indicated via the PPDU frame or a coordinated trigger request frame.

Clause 103: The first STA of any of clauses 97-102, where the acknowledgment message includes a block acknowledgment frame.

Clause 104: A first AP, including: a processing system that includes processor circuitry and memory circuitry that stores code, the processing system configured to cause the first AP to: transmit a scheduling frame in accordance with the first AP having less than a threshold quantity of spatial dimensions to support a CBF transmission mode during a TXOP, where the scheduling frame includes first information associated with coordination of resources of the TXOP; and communicate with one or more first STAs during the TXOP in accordance with the scheduling frame.

Clause 105: The first AP of clause 104, where, to transmit the scheduling frame, the processing system is configured to cause the first AP to: transmit, to a second AP, a CSR trigger frame, where the first information includes synchronization information associated with communications with the one or more first STAs during the TXOP.

Clause 106: The first AP of clause 105, where the CSR trigger frame is transmitted in accordance with the one or more first STAs being subject to less than a threshold level of interference by the second AP during communications via the TXOP.

Clause 107: The first AP of any of clauses 104-106, where the scheduling frame is transmitted to the one or more first STAs in accordance with the one or more first STAs being subject to greater than a threshold level of interference by a second AP during communications via the TXOP.

Clause 108: The first AP of any of clauses 104-107, where, to communicate the one or more first STAs, the processing system is configured to cause the first AP to: communicate with the one or more first STAs in accordance with a CSR mode or a dedicated TXOP mode.

Clause 109: A first AP for wireless communications, including: means for transmitting, to a second AP, a coordinated trigger request frame including first information associated with coordination of resources of a TXOP, where the first information includes one or more first identifiers associated with scheduling communications between one or more first STAs and the first AP during the TXOP; means for receiving, from the second AP, a first response to the coordinated trigger request frame, where the first response includes second information associated with the coordination of the resources, where the second information is indicative of whether the second AP can attenuate a first transmit signal at the one or more first STAs during the TXOP; and means for communicating, during the TXOP and in accordance with the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 110: The first AP of clause 109, further including: means for receiving, from the one or more first STAs during a measurement phase performed between the first AP and the second AP prior to transmission of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 111: The first AP of any of clauses 109-110, further including: means for receiving, from one or more second STAs associated with the second AP and during a measurement phase performed between the first AP and the second AP prior to transmission of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 112: The first AP of any of clauses 109-111, where transmitting a CBF trigger frame as the coordinated trigger request frame in accordance with the first AP having a threshold quantity of spatial dimensions to support a CBF transmission mode during the TXOP.

Clause 113: The first AP of any of clauses 109-112, further including: means for evaluating whether the first AP can attenuate second transmit signal at one or more second STAs associated with the second AP during the TXOP, where the second information of the first response includes one or more second identifiers associated with scheduling communications between the one or more second STAs and the second AP and where the first AP communicates the one or more messages of the transmission mode from the set of transmission modes in accordance with whether the first AP can an attenuate the second transmit signal.

Clause 114: The first AP of any of clauses 109-113, where the means for communicating the one or more messages of the transmission mode include: means for transmitting, to the second AP, a second response to the first response, where the second response includes third information that indicates that the first AP can attenuate a second transmit signal associated with communications between the second AP and one or more second STAs during the TXOP, where the second information of the first response includes one or more second identifiers associated with scheduling communications between the one or more second STAs and the second AP; and means for transmitting to the one or more first STAs, during the TXOP in accordance with the symmetric CBF transmission mode, one or more downlink messages, where the symmetric CBF transmission mode is used in accordance with the second AP being capable of attenuating the first transmit signal and the first AP being capable of attenuating the second transmit signal.

Clause 115: The first AP of clause 114, where the third information includes synchronization information associated with the communications during the TXOP in accordance with the symmetric CBF transmission mode.

Clause 116: The first AP of any of clauses 109-113, where the means for communicating the one or more messages of the transmission mode include: means for transmitting to the one or more first STAs during the TXOP in accordance with the asymmetric CBF transmission mode, one or more downlink messages, where the asymmetric CBF transmission mode is used in accordance with the second AP being capable of attenuating the first transmit signal and the first AP being incapable of attenuating a second transmit signal associated with communications between the second AP and one or more second STAs during the TXOP.

Clause 117: The first AP of clause 116, further including: means for transmitting, to the second AP, a second response to the first response, where the second response includes third information that indicates that the first AP cannot attenuate the second transmit signal associated with communications between the second AP and the one or more second STAs during the TXOP, where the second information of the first response includes one or more second identifiers associated with scheduling communications between the one or more second STAs and the second AP and the third information includes synchronization information associated with the communications during the TXOP in accordance with the asymmetric CBF transmission mode.

Clause 118: The first AP of any of clauses 109-113, where the means for communicating the one or more messages of the transmission mode include: means for transmitting, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and means for transmitting, to the one or more first STAs during the TXOP in accordance with the CSR transmission mode, one or more downlink messages.

Clause 119: The first AP of any of clauses 109-113, where the means for communicating the one or more messages of the transmission mode include: means for transmitting, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and means for transmitting, to the one or more first STAs in accordance with the one or more first STAs being schedulable via the TXOP used by the second AP and the second AP being incapable of attenuating the first transmit signal, one or more downlink messages during the TXOP via the dedicated TXOP transmission mode.

Clause 120: The first AP of any of clauses 109-113, where the means for communicating the one or more messages of the transmission mode include: means for transmitting, in accordance with the one or more first STAs being subject to at least a threshold level of interference during communications via the TXOP when used by the second AP and the second AP being incapable of attenuating the first transmit signal, one or more downlink messages to the one or more first STAs during the TXOP in accordance with the dedicated TXOP transmission mode.

Clause 121: The first AP of any of clauses 109-120, where the means for communicating the one or more messages of the transmission mode include: means for transmitting, to the one or more first STAs, a data message during a PPDU frame; and means for receiving, from the one or more first STAs and in accordance with the transmission mode, an acknowledgment message associated with the data message.

Clause 122: The first AP of clause 121, where the acknowledgment message is received within a resource unit that is positioned at an offset relative to the PPDU frame used to transmit the data message.

Clause 123: The first AP of any of clauses 121-122, further including: means for transmitting, to the one or more first STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 124: The first AP of any of clauses 121-123, where the acknowledgment message is received via a first set of resource units that are different from a second set of resource units used for the acknowledgment message sent by one or more second STAs to the second AP.

Clause 125: The first AP of clause 124, where the first set of resource units are indicated in the PPDU frame, the coordinated trigger request frame, or the first response.

Clause 126: The first AP of any of clauses 124-125, where the first set of resource units is assigned in accordance with one or more communications exchanged with the second AP.

Clause 127: The first AP of any of clauses 121-126, where the acknowledgment message includes a block acknowledgment frame.

Clause 128: The first AP of any of clauses 109-127, where the means for transmitting the coordinated trigger request frame include: means for transmitting the coordinated trigger request frame via a BSRP frame, where the BSRP frame includes an indication that the BSRP frame includes the coordinated trigger request frame.

Clause 129: The first AP of any of clauses 109-128, where the means for receiving the first response include: means for receiving an MBA frame including an indication that the MBA frame includes a CBF response frame message.

Clause 130: The first AP of any of clauses 109-129, further including: means for transmitting, a second response to the first response via a BSRP frame or a multi-STA block acknowledgment frame, where the second response includes third information that indicates whether the first AP can attenuate a second transmit signal associated with communications between the second AP and one or more second STAs during the TXOP.

Clause 131: A first AP for wireless communications, including: means for receiving, from a second AP, a coordinated trigger request frame including first information associated with coordination of resources of a TXOP, where the first information includes one or more first identifiers associated with scheduling communications between one or more first STAs and the second AP during the TXOP; means for transmitting, to the second AP, a first response to the coordinated trigger request frame, the first response including second information associated with the coordination of the resources, where the second information is indicative of whether the first AP can attenuate a first transmit signal at the one or more first STAs during the TXOP; and means for communicating, during the TXOP and in accordance the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 132: The first AP of clause 131, further including: means for receiving, from one or more second STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 133: The first AP of any of clauses 131-132, further including: means for receiving, from the one or more first STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 134: The first AP of any of clauses 131-133, where the means for communicating the one or more messages of the transmission mode include: means for receiving, from the second AP, a second response to the first response, where the second response includes third information that indicates that the second AP can attenuate a second transmit signal at one or more second STAs during the TXOP, where the second information of the first response includes one or more second identifiers associated with scheduling communications between the one or more second STAs and the first AP; and means for transmitting, to one or more second STAs during the TXOP in accordance with the symmetric CBF transmission mode, one or more downlink message, where the symmetric CBF transmission mode is used in accordance with the first AP being capable of attenuating the first transmit signal and the second AP being capable of attenuating the second transmit signal.

Clause 135: The first AP of clause 134, where the third information includes synchronization information associated with communications during the TXOP in accordance with the symmetric CBF transmission mode.

Clause 136: The first AP of any of clauses 131-133, where the means for communicating the one or more messages of the transmission mode include: means for transmitting, to one or more second STAs during the TXOP in accordance with the asymmetric CBF transmission mode, one or more downlink messages, where the asymmetric CBF transmission mode is used in accordance with the first AP being capable of attenuating the first transmit signal.

Clause 137: The first AP of clause 136, further including: means for receiving, from the second AP, a second response to the first response, where the second response includes third information that indicates that the second AP cannot attenuate a second transmit signal at the one or more second STAs during the TXOP, where the second information of the first response includes one or more second identifiers associated with scheduling communications between the one or more second STAs and the first AP.

Clause 138: The first AP of any of clauses 131-133, where the means for communicating the one or more messages of the transmission mode include: means for receiving, from the second AP in accordance with the first response, a CSR trigger frame message including third information associated with coordination of the resources; and means for transmitting, to one or more second STAs during the TXOP in accordance with the CSR transmission mode, one or more downlink messages.

Clause 139: The first AP of any of clauses 131-138, where the means for communicating the one or more messages include: means for transmitting, to one or more second STAs scheduled by the first AP during the TXOP, a data message via a PPDU frame; and means for receiving, from the one or more second STAs and in accordance with the transmission mode, an acknowledgment message associated with the data message.

Clause 140: The first AP of clause 139, where the acknowledgment message is received within a resource unit that is positioned at an offset relative to the PPDU frame used to transmit the data message.

Clause 141: The first AP of any of clauses 139-140, further including: means for transmitting, to the one or more second STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 142: The first AP of any of clauses 139-141, where the acknowledgment message is received via a first set of resource units of the TXOP that are different from a second set of resource units used for the acknowledgment message sent by the one or more first STAs to the first AP.

Clause 143: The first AP of clause 142, where the first set of resource units are indicated in the PPDU frame, the coordinated trigger request frame, or the first response.

Clause 144: The first AP of any of clauses 142-143, where the first set of resource units is assigned in accordance with one or more communications exchanged with the second AP.

Clause 145: The first AP of any of clauses 139-144, where the acknowledgment message includes a block acknowledgment frame.

Clause 146: The first AP of any of clauses 131-145, where the means for receiving the coordinated trigger request frame include: means for receiving the coordinated trigger request frame via a BSRP frame, where BSRP frame includes an indication that the BSRP frame includes the coordinated trigger request frame.

Clause 147: The first AP of any of clauses 131-146, where the means for transmitting the first response include: means for transmitting the first response via an MBA frame including an indication that the MBA frame includes the first response that is a CBF response frame message.

Clause 148: The first AP of any of clauses 131-147, further including: means for receiving a second response to the first response via a BSRP frame or a multi-STA block acknowledgment frame, where the second response includes third information that indicates whether the second AP can attenuate a second null signal to one or more second STAs to be scheduled for communications with the first AP during the TXOP.

Clause 149: A first STA for wireless communications, including: means for receiving, from a first AP, an NDPA frame message including coordination information with a second AP; means for receiving, from the first AP in accordance with the NDPA frame message, a first NDP frame message; means for receiving, from the second AP in accordance with the NDPA frame message, a second NDP frame message; means for transmitting a CSI reporting frame including first measurement information associated with measurement of the first NDP frame message and a second measurement information associated with measurement of the second NDP frame message; and means for communicating with the first AP in accordance with transmission of the channel measurement information.

Clause 150: The first STA of clause 149, where the first measurement information includes first channel state information associated with the first NDP frame message and a first received signal strength indicator associated with the first NDP frame message and the second measurement information includes second channel state information associated with the second NDP frame message and a second received signal strength indicator associated with the second NDP frame message.

Clause 151: The first STA of any of clauses 149-150, where the means for communicating with the first AP include: means for receiving, from the first AP, one or more downlink messages during a PPDU frame of a TXOP; and means for transmitting, to the first AP, an acknowledgment message associated with the one or more downlink messages.

Clause 152: The first STA of clause 151, further including: means for receiving, from the first AP in accordance with the first measurement information and the second measurement information, first information that schedules the first STA for communication during the TXOP, where the one or more downlink messages are received during the PPDU frame of the TXOP in accordance with the first information.

Clause 153: The first STA of any of clauses 151-152, where the acknowledgment message is transmitted during a resource that is positioned at an offset relative to the PPDU frame used to receive the one or more downlink messages.

Clause 154: The first STA of any of clauses 151-153, further including: means for receiving, from the first AP within a resource unit that is positioned at an offset relative to the PPDU frame used to receive the one or more downlink messages, a block acknowledgment request frame message, where the acknowledgment message is transmitted in accordance with receiving the block acknowledgment request frame message.

Clause 155: The first STA of any of clauses 151-154, where the acknowledgment message is transmitted via a first set of resource units that are different from a second set of resource units used for an acknowledgment message sent by one or more second STAs to the second AP.

Clause 156: The first STA of clause 155, where the first set of resource units is indicated via the PPDU frame or a coordinated trigger request frame.

Clause 157: The first STA of any of clauses 151-156, where the acknowledgment message includes a block acknowledgment frame.

Clause 158: A first AP for wireless communications, including: means for transmitting a scheduling frame in accordance with the first AP having less than a threshold quantity of spatial dimensions to support a CBF transmission mode during a TXOP, where the scheduling frame includes first information associated with coordination of resources of the TXOP; and means for communicating with one or more first STAs during the TXOP in accordance with the scheduling frame.

Clause 159: The first AP of clause 158, where the means for transmitting the scheduling frame include: means for transmitting, to a second AP, a CSR trigger frame, where the first information includes synchronization information associated with communications with the one or more first STAs during the TXOP.

Clause 160: The first AP of clause 159, where the CSR trigger frame is transmitted in accordance with the one or more first STAs being subject to less than a threshold level of interference by the second AP during communications via the TXOP.

Clause 161: The first AP of any of clauses 158-160, where the scheduling frame is transmitted to the one or more first STAs in accordance with the one or more first STAs being subject to greater than a threshold level of interference by a second AP during communications via the TXOP.

Clause 162: The first AP of any of clauses 158-161, where the means for communicating the one or more first STAs include: means for communicating with the one or more first STAs in accordance with a CSR mode or a dedicated TXOP mode.

Clause 163: A non-transitory computer-readable medium storing code for wireless communications, the code including instructions executable by one or more processors to: transmit, to a second AP, a coordinated trigger request frame including first information associated with coordination of resources of a TXOP, where the first information includes one or more first identifiers associated with scheduling communications between one or more first STAs and the first AP during the TXOP; receive, from the second AP, a first response to the coordinated trigger request frame, where the first response includes second information associated with the coordination of the resources, where the second information is indicative of whether the second AP can attenuate a first transmit signal at the one or more first STAs during the TXOP; and communicate, during the TXOP and in accordance with the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 164: The non-transitory computer-readable medium of clause 163, where the instructions are further executable by the one or more processors to: receive, from the one or more first STAs during a measurement phase performed between the first AP and the second AP prior to transmission of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 165: The non-transitory computer-readable medium of any of clauses 163-164, where the instructions are further executable by the one or more processors to: receive, from one or more second STAs associated with the second AP and during a measurement phase performed between the first AP and the second AP prior to transmission of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 166: The non-transitory computer-readable medium of any of clauses 163-165, where transmitting a CBF trigger frame as the coordinated trigger request frame in accordance with the first AP having a threshold quantity of spatial dimensions to support a CBF transmission mode during the TXOP.

Clause 167: The non-transitory computer-readable medium of any of clauses 163-166, where the instructions are further executable by the one or more processors to: evaluate whether the first AP can attenuate second transmit signal at one or more second STAs associated with the second AP during the TXOP, where the second information of the first response includes one or more second identifiers associated with scheduling communications between the one or more second STAs and the second AP and where the first AP communicates the one or more messages of the transmission mode from the set of transmission modes in accordance with whether the first AP can an attenuate the second transmit signal.

Clause 168: The non-transitory computer-readable medium of any of clauses 163-167, wherein the code to communicate the one or more messages of the transmission mode are executable by the one or more processors to: transmit, to the second AP, a second response to the first response, where the second response includes third information that indicates that the first AP can attenuate a second transmit signal associated with communications between the second AP and one or more second STAs during the TXOP, where the second information of the first response includes one or more second identifiers associated with scheduling communications between the one or more second STAs and the second AP; and transmit to the one or more first STAs, during the TXOP in accordance with the symmetric CBF transmission mode, one or more downlink messages, where the symmetric CBF transmission mode is used in accordance with the second AP being capable of attenuating the first transmit signal and the first AP being capable of attenuating the second transmit signal.

Clause 169: The non-transitory computer-readable medium of clause 168, where the third information includes synchronization information associated with the communications during the TXOP in accordance with the symmetric CBF transmission mode.

Clause 170: The non-transitory computer-readable medium of any of clauses 163-167, wherein the code to communicate the one or more messages of the transmission mode are executable by the one or more processors to: transmit to the one or more first STAs during the TXOP in accordance with the asymmetric CBF transmission mode, one or more downlink messages, where the asymmetric CBF transmission mode is used in accordance with the second AP being capable of attenuating the first transmit signal and the first AP being incapable of attenuating a second transmit signal associated with communications between the second AP and one or more second STAs during the TXOP.

Clause 171: The non-transitory computer-readable medium of clause 170, where the instructions are further executable by the one or more processors to: transmit, to the second AP, a second response to the first response, where the second response includes third information that indicates that the first AP cannot attenuate the second transmit signal associated with communications between the second AP and the one or more second STAs during the TXOP, where the second information of the first response includes one or more second identifiers associated with scheduling communications between the one or more second STAs and the second AP and the third information includes synchronization information associated with the communications during the TXOP in accordance with the asymmetric CBF transmission mode.

Clause 172: The non-transitory computer-readable medium of any of clauses 163-167, wherein the code to communicate the one or more messages of the transmission mode are executable by the one or more processors to: transmit, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and transmit, to the one or more first STAs during the TXOP in accordance with the CSR transmission mode, one or more downlink messages.

Clause 173: The non-transitory computer-readable medium of any of clauses 163-167, wherein the code to communicate the one or more messages of the transmission mode are executable by the one or more processors to: transmit, to the second AP, a CSR trigger frame message including third information associated with coordination of the resources, where the CSR trigger frame message is transmitted in accordance with the one or more first STAs being schedulable during the TXOP used by the second AP and the second AP being incapable of attenuating the first transmit signal during the TXOP; and transmit, to the one or more first STAs in accordance with the one or more first STAs being schedulable via the TXOP used by the second AP and the second AP being incapable of attenuating the first transmit signal, one or more downlink messages during the TXOP via the dedicated TXOP transmission mode.

Clause 174: The non-transitory computer-readable medium of any of clauses 163-167, wherein the code to communicate the one or more messages of the transmission mode are executable by the one or more processors to: transmit, in accordance with the one or more first STAs being subject to at least a threshold level of interference during communications via the TXOP when used by the second AP and the second AP being incapable of attenuating the first transmit signal, one or more downlink messages to the one or more first STAs during the TXOP in accordance with the dedicated TXOP transmission mode.

Clause 175: The non-transitory computer-readable medium of any of clauses 163-174, wherein the code to communicate the one or more messages of the transmission mode are executable by the one or more processors to: transmit, to the one or more first STAs, a data message during a PPDU frame; and receive, from the one or more first STAs and in accordance with the transmission mode, an acknowledgment message associated with the data message.

Clause 176: The non-transitory computer-readable medium of clause 175, where the acknowledgment message is received within a resource unit that is positioned at an offset relative to the PPDU frame used to transmit the data message.

Clause 177: The non-transitory computer-readable medium of any of clauses 175-176, where the instructions are further executable by the one or more processors to: transmit, to the one or more first STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 178: The non-transitory computer-readable medium of any of clauses 175-177, where the acknowledgment message is received via a first set of resource units that are different from a second set of resource units used for the acknowledgment message sent by one or more second STAs to the second AP.

Clause 179: The non-transitory computer-readable medium of clause 178, where the first set of resource units are indicated in the PPDU frame, the coordinated trigger request frame, or the first response.

Clause 180: The non-transitory computer-readable medium of any of clauses 178-179, where the first set of resource units is assigned in accordance with one or more communications exchanged with the second AP.

Clause 181: The non-transitory computer-readable medium of any of clauses 175-180, where the acknowledgment message includes a block acknowledgment frame.

Clause 182: The non-transitory computer-readable medium of any of clauses 163-181, wherein the code to transmit the coordinated trigger request frame are executable by the one or more processors to: transmit the coordinated trigger request frame via a BSRP frame, where the BSRP frame includes an indication that the BSRP frame includes the coordinated trigger request frame.

Clause 183: The non-transitory computer-readable medium of any of clauses 163-182, wherein the code to receive the first response are executable by the one or more processors to: receive an MBA frame including an indication that the MBA frame includes a CBF response frame message.

Clause 184: The non-transitory computer-readable medium of any of clauses 163-183, where the instructions are further executable by the one or more processors to: transmit, a second response to the first response via a BSRP frame or a multi-STA block acknowledgment frame, where the second response includes third information that indicates whether the first AP can attenuate a second transmit signal associated with communications between the second AP and one or more second STAs during the TXOP.

Clause 185: A non-transitory computer-readable medium storing code for wireless communications, the code including instructions executable by one or more processors to: receive, from a second AP, a coordinated trigger request frame including first information associated with coordination of resources of a TXOP, where the first information includes one or more first identifiers associated with scheduling communications between one or more first STAs and the second AP during the TXOP; transmit, to the second AP, a first response to the coordinated trigger request frame, the first response including second information associated with the coordination of the resources, where the second information is indicative of whether the first AP can attenuate a first transmit signal at the one or more first STAs during the TXOP; and communicate, during the TXOP and in accordance the second information of the first response, one or more messages of a transmission mode from a set of transmission modes including a symmetric CBF transmission mode, an asymmetric CBF transmission mode, a CSR transmission mode, or a dedicated TXOP transmission mode.

Clause 186: The non-transitory computer-readable medium of clause 185, where the instructions are further executable by the one or more processors to: receive, from one or more second STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP, where the coordinated trigger request frame is transmitted in accordance with the measurement information.

Clause 187: The non-transitory computer-readable medium of any of clauses 185-186, where the instructions are further executable by the one or more processors to: receive, from the one or more first STAs during a measurement phase performed between the first AP and the second AP prior to receipt of the coordinated trigger request frame, measurement information associated with communications by the first AP and received signal strength information associated with a first frame transmitted by the first AP and a second frame transmitted by the second AP where the coordinated trigger request frame is transmitted in accordance with the measurement information.

Clause 188: The non-transitory computer-readable medium of any of clauses 185-187, wherein the code to communicate the one or more messages of the transmission mode are executable by the one or more processors to: receive, from the second AP, a second response to the first response, where the second response includes third information that indicates that the second AP can attenuate a second transmit signal at one or more second STAs during the TXOP, where the second information of the first response includes one or more second identifiers associated with scheduling communications between the one or more second STAs and the first AP; and transmit, to one or more second STAs during the TXOP in accordance with the symmetric CBF transmission mode, one or more downlink message, where the symmetric CBF transmission mode is used in accordance with the first AP being capable of attenuating the first transmit signal and the second AP being capable of attenuating the second transmit signal.

Clause 189: The non-transitory computer-readable medium of clause 188, where the third information includes synchronization information associated with communications during the TXOP in accordance with the symmetric CBF transmission mode.

Clause 190: The non-transitory computer-readable medium of any of clauses 185-187, wherein the code to communicate the one or more messages of the transmission mode are executable by the one or more processors to: transmit, to one or more second STAs during the TXOP in accordance with the asymmetric CBF transmission mode, one or more downlink messages, where the asymmetric CBF transmission mode is used in accordance with the first AP being capable of attenuating the first transmit signal.

Clause 191: The non-transitory computer-readable medium of clause 190, where the instructions are further executable by the one or more processors to: receive, from the second AP, a second response to the first response, where the second response includes third information that indicates that the second AP cannot attenuate a second transmit signal at the one or more second STAs during the TXOP, where the second information of the first response includes one or more second identifiers associated with scheduling communications between the one or more second STAs and the first AP.

Clause 192: The non-transitory computer-readable medium of any of clauses 185-187, wherein the code to communicate the one or more messages of the transmission mode are executable by the one or more processors to: receive, from the second AP in accordance with the first response, a CSR trigger frame message including third information associated with coordination of the resources; and transmit, to one or more second STAs during the TXOP in accordance with the CSR transmission mode, one or more downlink messages.

Clause 193: The non-transitory computer-readable medium of any of clauses 185-192, wherein the code to communicate the one or more messages are executable by the one or more processors to: transmit, to one or more second STAs scheduled by the first AP during the TXOP, a data message via a physical layer protocol data unit PPDU frame; and receive, from the one or more second STAs and in accordance with the transmission mode, an acknowledgment message associated with the data message.

Clause 194: The non-transitory computer-readable medium of clause 193, where the acknowledgment message is received within a resource unit that is positioned at an offset relative to the PPDU frame used to transmit the data message.

Clause 195: The non-transitory computer-readable medium of any of clauses 193-194, where the instructions are further executable by the one or more processors to: transmit, to the one or more second STAs in accordance with the transmission mode and within a resource unit that is positioned at an offset relative to the PPDU frame used to transmit the data message, a block acknowledgment request frame message, where the acknowledgment message is received after transmitting the block acknowledgment request frame message.

Clause 196: The non-transitory computer-readable medium of any of clauses 193-195, where the acknowledgment message is received via a first set of resource units of the TXOP that are different from a second set of resource units used for the acknowledgment message sent by the one or more first STAs to the first AP.

Clause 197: The non-transitory computer-readable medium of clause 196, where the first set of resource units are indicated in the PPDU frame, the coordinated trigger request frame, or the first response.

Clause 198: The non-transitory computer-readable medium of any of clauses 196-197, where the first set of resource units is assigned in accordance with one or more communications exchanged with the second AP.

Clause 199: The non-transitory computer-readable medium of any of clauses 193-198, where the acknowledgment message includes a block acknowledgment frame.

Clause 200: The non-transitory computer-readable medium of any of clauses 185-199, wherein the code to receive the coordinated trigger request frame are executable by the one or more processors to: receive the coordinated trigger request frame via a BSRP frame, where BSRP frame includes an indication that the BSRP frame includes the coordinated trigger request frame.

Clause 201: The non-transitory computer-readable medium of any of clauses 185-200, wherein the code to transmit the first response are executable by the one or more processors to: transmit the first response vian MBA frame including an indication that the MBA frame includes the first response that is a CBF response frame message.

Clause 202: The non-transitory computer-readable medium of any of clauses 185-201, where the instructions are further executable by the one or more processors to: receive a second response to the first response via a BSRP frame or a multi-STA block acknowledgment frame, where the second response includes third information that indicates whether the second AP can attenuate a second null signal to one or more second STAs to be scheduled for communications with the first AP during the TXOP.

Clause 203: A non-transitory computer-readable medium storing code for wireless communications, the code including instructions executable by one or more processors to: receive, from a first AP, an NDPA frame message including coordination information with a second AP; receive, from the first AP in accordance with the NDPA frame message, a first NDP frame message; receive, from the second AP in accordance with the NDPA frame message, a second NDP frame message; transmit a CSI reporting frame including first measurement information associated with measurement of the first NDP frame message and a second measurement information associated with measurement of the second NDP frame message; and communicate with the first AP in accordance with transmission of the channel measurement information.

Clause 204: The non-transitory computer-readable medium of clause 203, where the first measurement information includes first channel state information associated with the first NDP frame message and a first received signal strength indicator associated with the first NDP frame message and the second measurement information includes second channel state information associated with the second NDP frame message and a second received signal strength indicator associated with the second NDP frame message.

Clause 205: The non-transitory computer-readable medium of any of clauses 203-204, where the code to communicate with the first AP is executable by the one or more processors to: receive, from the first AP, one or more downlink messages during a PPDU frame of a TXOP; and transmit, to the first AP, an acknowledgment message associated with the one or more downlink messages.

Clause 206: The non-transitory computer-readable medium of clause 205, where the instructions are further executable by the one or more processors to: receive, from the first AP in accordance with the first measurement information and the second measurement information, first information that schedules the first STA for communication during the TXOP, where the one or more downlink messages are received during the PPDU frame of the TXOP in accordance with the first information.

Clause 207: The non-transitory computer-readable medium of any of clauses 205-206, where the acknowledgment message is transmitted during a resource that is positioned at an offset relative to the PPDU frame used to receive the one or more downlink messages.

Clause 208: The non-transitory computer-readable medium of any of clauses 205-207, where the instructions are further executable by the one or more processors to: receive, from the first AP within a resource unit that is positioned at an offset relative to the PPDU frame used to receive the one or more downlink messages, a block acknowledgment request frame message, where the acknowledgment message is transmitted in accordance with receiving the block acknowledgment request frame message.

Clause 209: The non-transitory computer-readable medium of any of clauses 205-208, where the acknowledgment message is transmitted via a first set of resource units that are different from a second set of resource units used for an acknowledgment message sent by one or more second STAs to the second AP.

Clause 210: The non-transitory computer-readable medium of clause 209, where the first set of resource units is indicated via the PPDU frame or a coordinated trigger request frame.

Clause 211: The non-transitory computer-readable medium of any of clauses 205-210, where the acknowledgment message includes a block acknowledgment frame.

Clause 212: A non-transitory computer-readable medium storing code for wireless communications, the code including instructions executable by one or more processors to: transmit a scheduling frame in accordance with the first AP having less than a threshold quantity of spatial dimensions to support a CBF transmission mode during a TXOP, where the scheduling frame includes first information associated with coordination of resources of the TXOP; and communicate with one or more first STAs during the TXOP in accordance with the scheduling frame.

Clause 213: The non-transitory computer-readable medium of clause 212, wherein the code to transmit the scheduling frame are executable by the one or more processors to: transmit, to a second AP, a CSR trigger frame, where the first information includes synchronization information associated with communications with the one or more first STAs during the TXOP.

Clause 214: The non-transitory computer-readable medium of clause 213, where the CSR trigger frame is transmitted in accordance with the one or more first STAs being subject to less than a threshold level of interference by the second AP during communications via the TXOP.

Clause 215: The non-transitory computer-readable medium of any of clauses 212-214, where the scheduling frame is transmitted to the one or more first STAs in accordance with the one or more first STAs being subject to greater than a threshold level of interference by a second AP during communications via the TXOP.

Clause 216: The non-transitory computer-readable medium of any of clauses 212-215, wherein the code to communicate the one or more first STAs are executable by the one or more processors to: communicate with the one or more first STAs in accordance with a CSR mode or a dedicated TXOP mode.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this is not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above are not to be understood as requiring such separation in all examples, and it is to be understood that the described program components and systems can generally be integrated together in a single software product or packaged into multiple software products.

What is claimed is:

1. A first access point, comprising:
a processing system that includes processor circuitry and memory circuitry that stores code, the processing system configured to cause the first access point to:
transmit, to a second access point, a coordinated trigger request frame comprising first information associated with coordination of resources of a transmission opportunity;
receive, from the second access point, a first response to the coordinated trigger request frame, wherein the first response comprises second information associated with the coordination of the resources; and
communicate, during the transmission opportunity and in accordance with the second information of the first response, one or more messages of a transmission mode from a set of transmission modes comprising a coordinated transmission mode and a dedicated transmission opportunity transmission mode.

2. The first access point of claim 1, wherein, to transmit the coordinated trigger request frame, the processing system is configured to cause the first access point to:
transmit the coordinated trigger request frame via a buffer status report poll frame, wherein the buffer status report poll frame comprises an indication that the buffer status report poll frame comprises the coordinated trigger request frame.

3. The first access point of claim 2, wherein a user information field of the buffer status report poll frame indicates that the buffer status report poll frame is the coordinated trigger request frame.

4. The first access point of claim 1, wherein, to receive the first response, the processing system is configured to cause the first access point to:
receive the first response via a multi-station block acknowledgment (Multi-STA BlockAck) frame, wherein the Multi-STA BlockAck frame comprises an indication that the Multi-STA BlockAck frame comprises the first response.

5. The first access point of claim 1, wherein the coordinated trigger request frame indicates an intent to share the transmission opportunity with the second access point and to operate in accordance with the coordinated transmission mode within the transmission opportunity.

6. The first access point of claim 1, wherein:
the first information comprises one or more first identifiers associated with scheduling communications between one or more first stations and the first access point during the transmission opportunity; and
the second information of the first response comprises one or more second identifiers associated with scheduling communications between one or more second stations and the second access point during the transmission opportunity.

7. The first access point of claim 6, wherein:
the first information comprises an indication of a first number of spatial streams for each STA of the one or more first stations; and
the second information comprises an indication of a second number of spatial streams for each STA of the one or more second stations.

8. The first access point of claim 1, wherein the coordinated transmission mode is a coordinated beamforming transmission mode or a coordinated spatial reuse transmission mode.

9. The first access point of claim 1, wherein the first response is a coordinated beamforming response frame.

10. The first access point of claim 1, wherein the second information is indicative of whether the second access point can attenuate a transmit signal at one or more first stations associated with the first access point during the transmission opportunity.

11. The first access point of claim 10, wherein, to communicate the one or more messages of the transmission mode, the processing system is configured to cause the first access point to:
transmit one or more downlink messages to the one or more first stations during the transmission opportunity in accordance with a coordinated beamforming transmission mode, wherein the coordinated beamforming transmission mode is used in accordance with the second access point being capable of attenuating the transmit signal; or
transmit the one or more downlink messages to the one or more first stations during the transmission opportunity in accordance with the dedicated transmission opportunity transmission mode, wherein the dedicated transmission opportunity transmission mode is used in accordance with the second access point being incapable of attenuating the transmit signal.

12. A first access point, comprising:
a processing system that includes processor circuitry and memory circuitry that stores code, the processing system configured to cause the first access point to:
receive, from a second access point, a coordinated trigger request frame comprising first information associated with coordination of resources of a transmission opportunity;
transmit, to the second access point, a first response to the coordinated trigger request frame, the first response comprising second information associated with the coordination of the resources; and
communicate, during the transmission opportunity and in accordance the second information of the first response, one or more messages of a transmission mode from a set of transmission modes comprising a coordinated transmission mode and a dedicated transmission opportunity transmission mode.

13. The first access point of claim 12, wherein the coordinated trigger request frame indicates an intent to share the transmission opportunity with the second access point and to operate in accordance with the coordinated transmission mode within the transmission opportunity, and wherein the coordinated transmission mode is a coordinated beamforming transmission mode or a coordinated spatial reuse transmission mode.

14. The first access point of claim 12, wherein:
the first information comprises one or more first identifiers associated with scheduling communications between one or more first stations and the first access point during the transmission opportunity; and
the second information of the first response comprises one or more second identifiers associated with scheduling communications between one or more second stations and the second access point during the transmission opportunity.

15. The first access point of claim 14, wherein:
the first information comprises an indication of a first number of spatial streams for each STA of the one or more first stations; and
the second information comprises an indication of a second number of spatial streams for each STA of the one or more second stations.

16. A method for wireless communications at a first access point, comprising:
transmitting, to a second access point, a coordinated trigger request frame comprising first information associated with coordination of resources of a transmission opportunity;
receiving, from the second access point, a first response to the coordinated trigger request frame, wherein the first response comprises second information associated with the coordination of the resources; and
communicating, during the transmission opportunity and in accordance with the second information of the first response, one or more messages of a transmission mode from a set of transmission modes comprising a coordinated transmission mode and a dedicated transmission opportunity transmission mode.

17. The method of claim 16, wherein further comprising:
receiving, from one or more first stations during a measurement phase performed between the first access point and the second access point prior to transmission of the coordinated trigger request frame, measurement information associated with communications by the first access point and received signal strength information associated with a first frame transmitted by the first access point and a second frame transmitted by the second access point, wherein the coordinated trigger request frame is transmitted in accordance with the measurement information.

18. The method of claim 16, further comprising:
receiving, from one or more second stations associated with the second access point and during a measurement phase performed between the first access point and the second access point prior to transmission of the coordinated trigger request frame, measurement information associated with communications by the first access point and received signal strength information associated with a first frame transmitted by the first access point and a second frame transmitted by the second access point wherein the coordinated trigger request frame is transmitted in accordance with the measurement information.

19. The method of claim 16, wherein transmitting the coordinated trigger request frame comprises:
transmitting a coordinated beamforming trigger frame as the coordinated trigger request frame in accordance with the first access point having a threshold quantity of spatial dimensions to support a coordinated beamforming transmission mode during the transmission opportunity.

20. The method of claim 16, further comprising:
evaluating whether the first access point can attenuate a transmit signal at one or more second stations associated with the second access point during the transmission opportunity, wherein the second information of the first response comprises one or more second identifiers associated with scheduling communications between the one or more second stations and the second access point, and wherein the first access point communicates the one or more messages of the transmission mode from the set of transmission modes in accordance with whether the first access point can attenuate the transmit signal.
